(19) United States
(12) Patent Application Publication
(10) Pub. No.: US 2025/0355700 A1
(43) Pub. Date: Nov. 20, 2025

(54) MIGRATION DESTINATION CONTROL APPARATUS, CONTROL MIGRATION METHOD, AND COMPUTER READABLE MEDIUM

(71) Applicant: Mitsubishi Electric Corporation, Tokyo (JP)

(72) Inventor: Koki IGAWA, Tokyo (JP)

(73) Assignee: Mitsubishi Electric Corporation, Tokyo (JP)

(21) Appl. No.: 19/282,611

(22) Filed: Jul. 28, 2025

Related U.S. Application Data
(63) Continuation of application No. PCT/JP2023/011830, filed on Mar. 24, 2023.

(51) Int. Cl. G06F 9/48

(52) U.S. Cl. CPC G06F 9/4875; G06F 2209/484

(57) ABSTRACT

A migration destination control apparatus (20) is to where control of a control target (40) is migrated from a migration source control apparatus (10) that controls the control target (40) by cyclically executing a computation process. In the migration destination control apparatus (20), an initial synchronization unit (242) obtains information that relates to the computation process of the migration source control apparatus (10) in a specified cycle as initial synchronization information. A computation reproduction unit (212), based on the initial synchronization information, executes a computation process that is executed in the migration source control apparatus (10) from a next computation cycle after the specified cycle to a migration cycle to where the control is migrated. A computation execution unit (211) controls the control target (40) by executing the computation process after the migration cycle using a result of the computation process that is executed by the computation reproduction unit (212).

### CROSS REFERENCE TO RELATED APPLICATION

This application is a Continuation of PCT International Application No. PCT/JP2023/011830, filed on Mar. 24, 2023, which is hereby expressly incorporated by reference into the present application.

### TECHNICAL FIELD

The present disclosure relates to technology to migrate control of a control target.

### BACKGROUND ART

There is a case where control of a production facility is performed by a form of a control system of which a control apparatus that performs a cyclic computation process and an input/output apparatus that performs input/output control of the control target are connected by a network. The control target, as a specific example, is a sensor, an actuator, or the like in the production facility. The input/output control by the input/output apparatus is control of output of a measurement value from the control target, input of a computation result of the control apparatus to the control target, or the like.

There is a case where a control apparatus in operation is exchanged with another control apparatus for a purpose of replacement, inspection, or the like. At this time, it is desirable that the control apparatus can be exchanged without stopping the production facility that is the control target to prevent decreased productivity.

To achieve this, it is sufficient when a state of a computation process of another control apparatus that is to be a migration destination can be synchronized with a state of a computation process of a control apparatus in operation that is to be a migration source and migrated while not affecting the control target.

As related conventional technology, there is recovery technology for a multiplexing system.

Recovery technology for multiple systems that match internal states of tasks of an active system and a standby system is stated in Patent Literature 1. The active system is equivalent to the migration source. The standby system is equivalent to the migration destination. Selecting either one of a first means and a second means is stated in Patent Literature 1. The first means is a means to transfer differential data of the internal state from the active system to the standby system, and to reflect the differential data to the standby system. The second means is a means to transfer an input log from the active system to the standby system, and the standby system replays a process of the active system based on the input log. Thus, reduction of multiple system recovery time is attempted in Patent Literature 1.

### CITATION LIST

### Patent Literature

Patent Literature 1: JP 2016-206865 A

### SUMMARY OF INVENTION

### Technical Problem

In the technology of Patent Literature 1, there may be a case where transfer time of data for state synchronization from the active system to the standby system is always longer than a cycle in which a task is executed. The data for the state synchronization is differential data or an input log. In this case, a process of the standby system cannot be caught up with a process of the active system.

Consequently, synchronization of the internal states of the tasks of the active system and the standby system is never completed.

The present disclosure aims to make a control apparatus exchangeable without stopping a control target even in a case where transfer time of data for state synchronization is longer than a cycle in which a computation process is executed.

### Solution to Problem

A migration destination control apparatus according to the present disclosure is a migration destination control apparatus to where control of a control target is migrated from a migration source control apparatus that controls the control target by cyclically executing a computation process, the migration destination control apparatus includes: an initial synchronization unit to obtain information that relates to the computation process of the migration source control apparatus in a specified cycle as initial synchronization information;

a computation reproduction unit, based on the initial synchronization information that is obtained by the initial synchronization unit, to execute the computation process that is executed in the migration source control apparatus from a next computation cycle after the specified cycle to a migration cycle to where control is migrated; and a computation execution unit to control the control target by executing the computation process after the migration cycle using a result of the computation process that is executed by the computation reproduction unit.

### Advantageous Effects of Invention In the present disclosure, based on information that relates to a computation

process of a migration source control apparatus in a specified cycle, a migration destination control apparatus executes a computation process that is executed in the migration source control apparatus from a next computation cycle after the specified cycle to a migration cycle in which control is migrated.

Thus, even in a case where transfer time of data for state synchronization is longer than a cycle in which the computation process is executed, it will be possible to synchronize, in the transfer cycle, a state of the computation process of the migration source control apparatus with a state of a computation process of the migration destination control apparatus. As a result, the control apparatus can be exchangeable without stopping a control target.

### BRIEF DESCRIPTION OF DRAWINGS

FIG. 1 is a configuration diagram of a control migration system 100 according to Embodiment 1.

FIG. 2 is a data flow diagram of a state before start of migration according to Embodiment 1.

FIG. 3 is a data flow diagram of a state during migration according to Embodiment 1.

FIG. 4 is a data flow diagram of a state during migration according to Embodiment 1.

FIG. 5 is a data flow diagram of a state after completion of migration according to Embodiment 1.

FIG. 6 is a hardware configuration diagram of a migration source control apparatus 10 and a migration destination control apparatus 20 according to Embodiment 1.

FIG. 7 is a hardware configuration diagram of an input/output apparatus 30 according to Embodiment 1.

FIG. 8 is a flowchart illustrating operation of a computation execution unit 111 of the migration source control apparatus 10 according to Embodiment 1.

FIG. 9 is a flowchart illustrating operation of an input/output control unit 31 of the input/output apparatus 30 according to Embodiment 1.

FIG. 10 is a flowchart illustrating operation of a migration execution unit 241 according to Embodiment 1.

FIG. 11 is a flowchart illustrating operation of a cycle computation unit 21 according to Embodiment 1.

FIG. 12 is a flowchart illustrating operation of a computation reproduction unit 212 according to Embodiment 1.

FIG. 13 is a flowchart illustrating operation of an initial synchronization unit 242 according to Embodiment 1.

FIG. 14 is a flowchart illustrating operation of a migration aid unit 14 according to Embodiment 1.

FIG. 15 is a flowchart illustrating operation of a migration aid unit 34 according to Embodiment 1.

FIG. 16 is an explanatory diagram of an example of a state of a computation data unit 22 in a state during migration according to Embodiment 1.

FIG. 17 is a configuration diagram of a control migration system 100 according 20 to Embodiment 2.

FIG. 18 is a flowchart illustrating operation of a migration execution unit 241 according to Embodiment 2.

FIG. 19 is a flowchart illustrating operation of a migration aid unit 14 according to Embodiment 2.

FIG. 20 is a flowchart illustrating operation of a collation information transfer unit 15 according to Embodiment 2.

FIG. 21 is a flowchart illustrating operation of a computation reproduction unit 212 according to Embodiment 2.

FIG. 22 is a flowchart illustrating operation of a collation obtaining unit 26 according to Embodiment 2.

FIG. 23 is a flowchart illustrating operation of a collation execution unit 27 according to Embodiment 2.

FIG. 24 is a configuration diagram of a control migration system 100 according to Embodiment 3.

FIG. 25 is a flowchart illustrating operation of an order determination unit 29 according to Embodiment 3.

FIG. 26 is an explanatory diagram of a specific example of a determination method of a migration order according to Embodiment 3.

FIG. 27 is an explanatory diagram of a specific example of a determination method of a migration order according to Embodiment 3.

### DESCRIPTION OF EMBODIMENTS

### Embodiment 1

### Description of Configuration

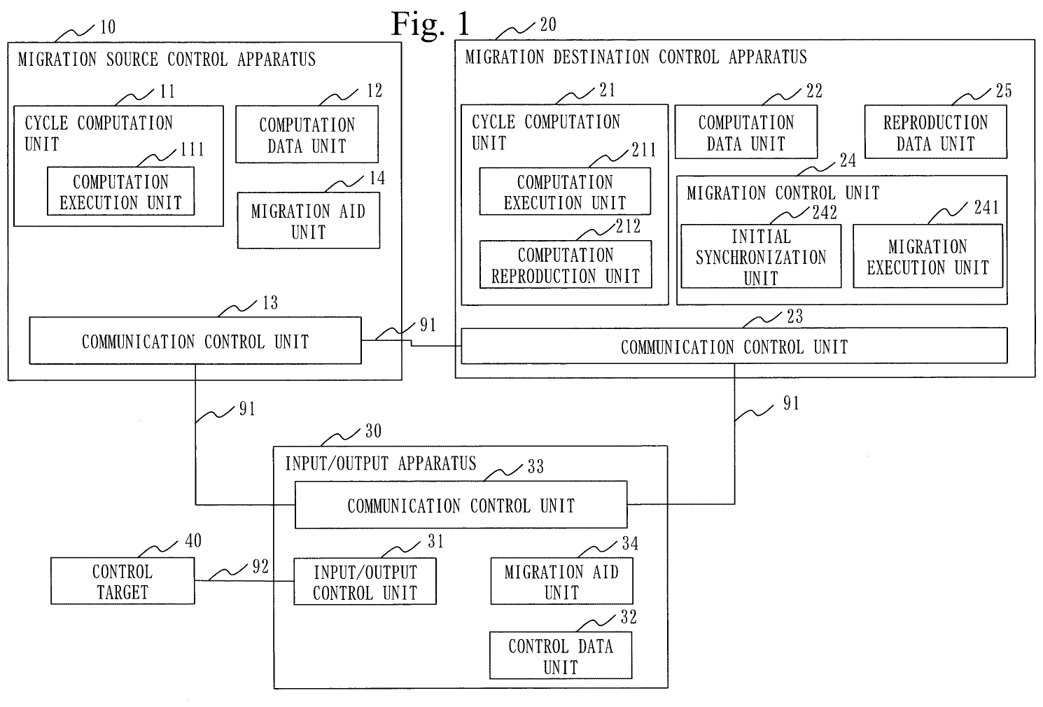

A configuration of a control migration system 100 according to Embodiment 1 will be described by referring to FIG. 1 to FIG. 5.

The control migration system 100 includes a migration source control apparatus 10, a migration destination control apparatus 20, and an input/output apparatus 30. The migration source control apparatus 10, the migration destination control apparatus 20, and the input/output apparatus 30 are connected through a network 91. The input/output apparatus 30 is connected to a control target 40 through a transmission channel 92.

Next, functions of the control migration system 100 will be described after describing states that the control migration system 100 has.

### States That Control Migration System 100 Has

The control migration system 100 has three states, a state before start of migration, a state during migration, and a state after completion of migration.

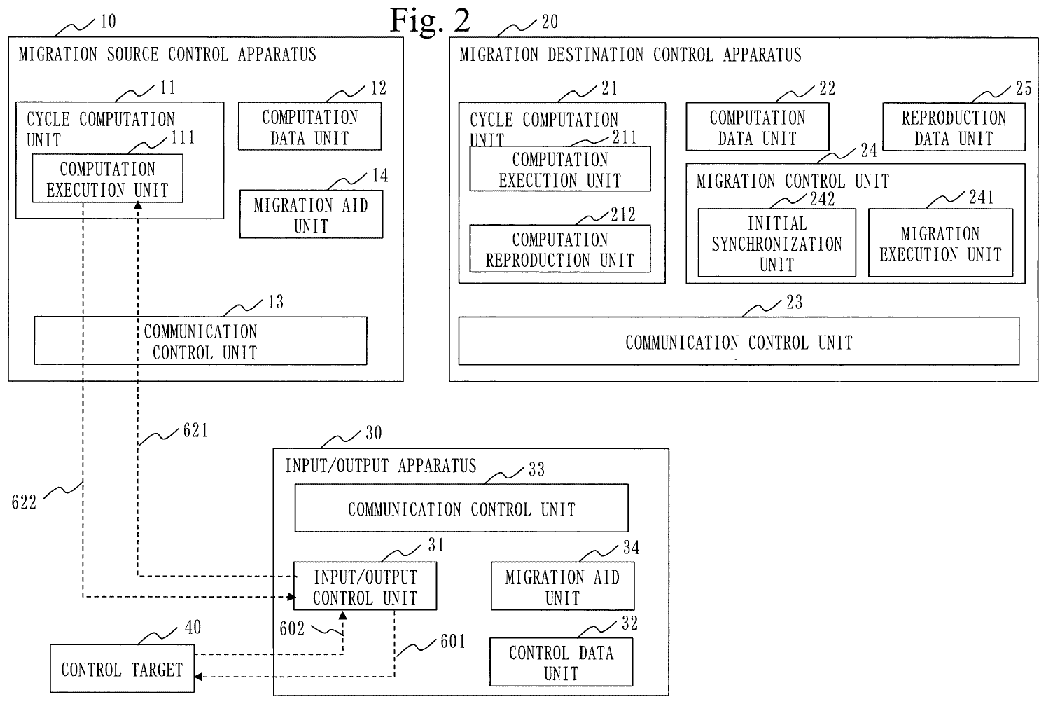

The state before start of migration is a state in which the migration source control apparatus 10 cooperatively operates with the input/output apparatus 30 through the network 91 to control the control target 40. FIG. 2 illustrates a data flow of the state before start of migration.

The state during migration is a state in which information in the migration source control apparatus 10 that is necessary to be synchronized is synchronized with the migration destination control apparatus 20, and a control apparatus that the input/output apparatus 30 cooperatively operates with is being switched from the migration source control apparatus 10 to the migration destination control apparatus 20. In the state during migration, the state is continued in which, in the state before start of migration, the migration source control apparatus 10 cooperatively operates with the input/output apparatus 30 through the network 91 to control the control target 40. In a final stage of the state during migration, the state in which, in the state before start of migration, the migration source control apparatus 10 cooperatively operates with the input/output apparatus 30 through the network 91 to control the control target 40 is in a continued state is switched to a state in which the migration destination control apparatus 20 cooperatively operates with the input/output apparatus 30 through the network 91 to control the control target 40.

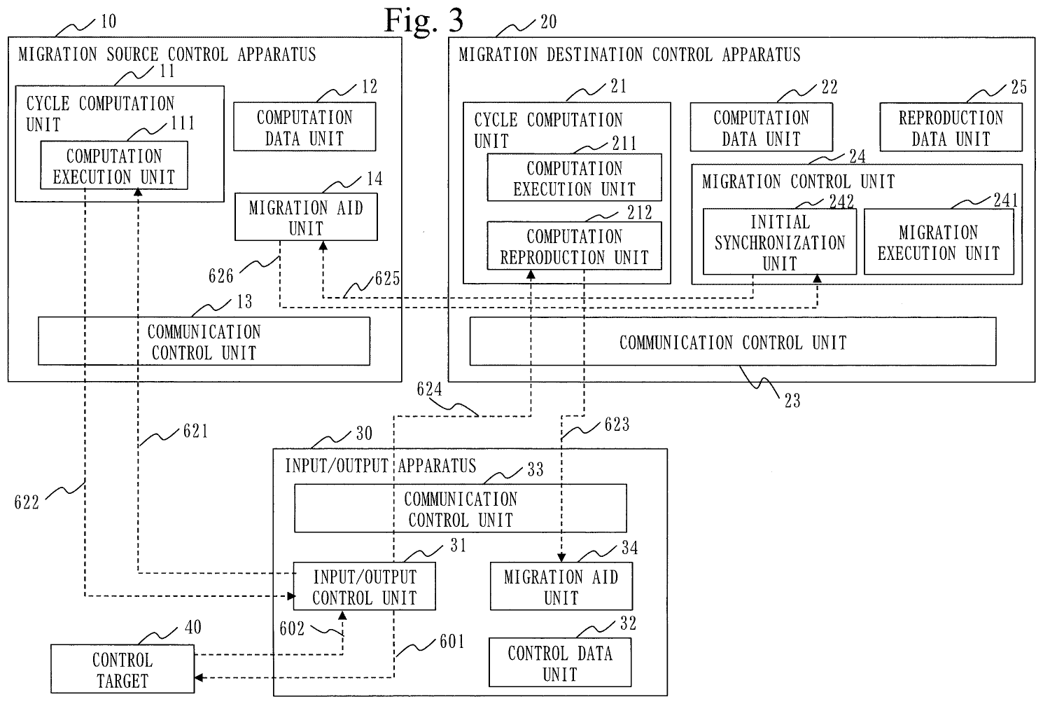

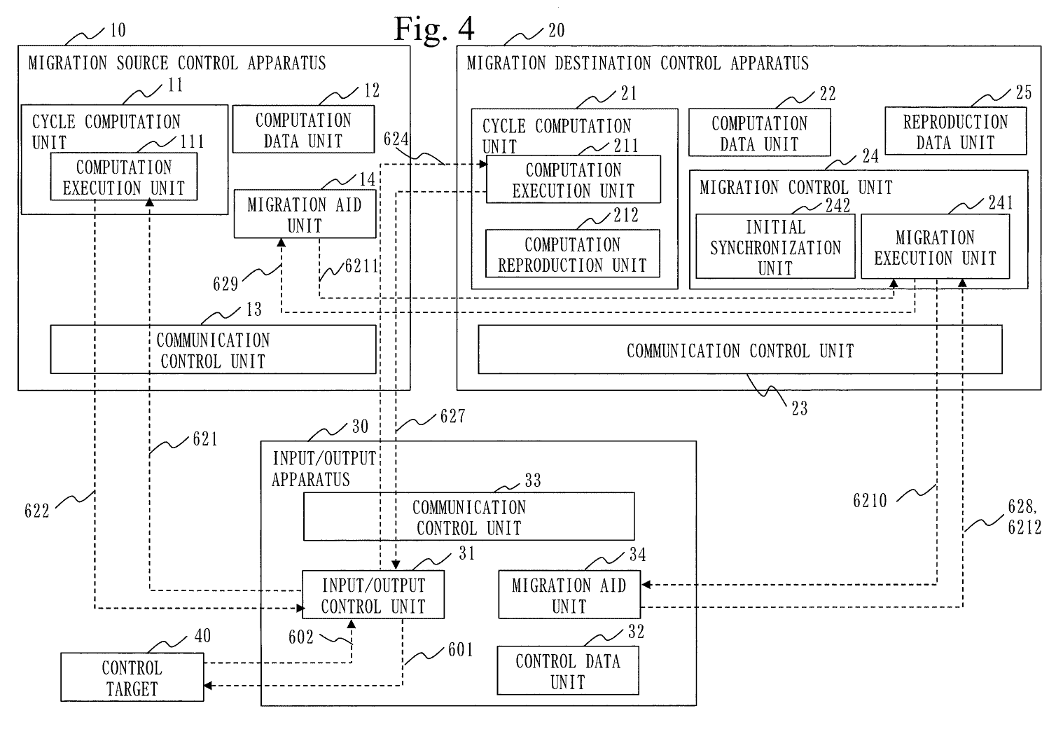

FIG. 3 and FIG. 4 illustrate data flows of the state during migration.

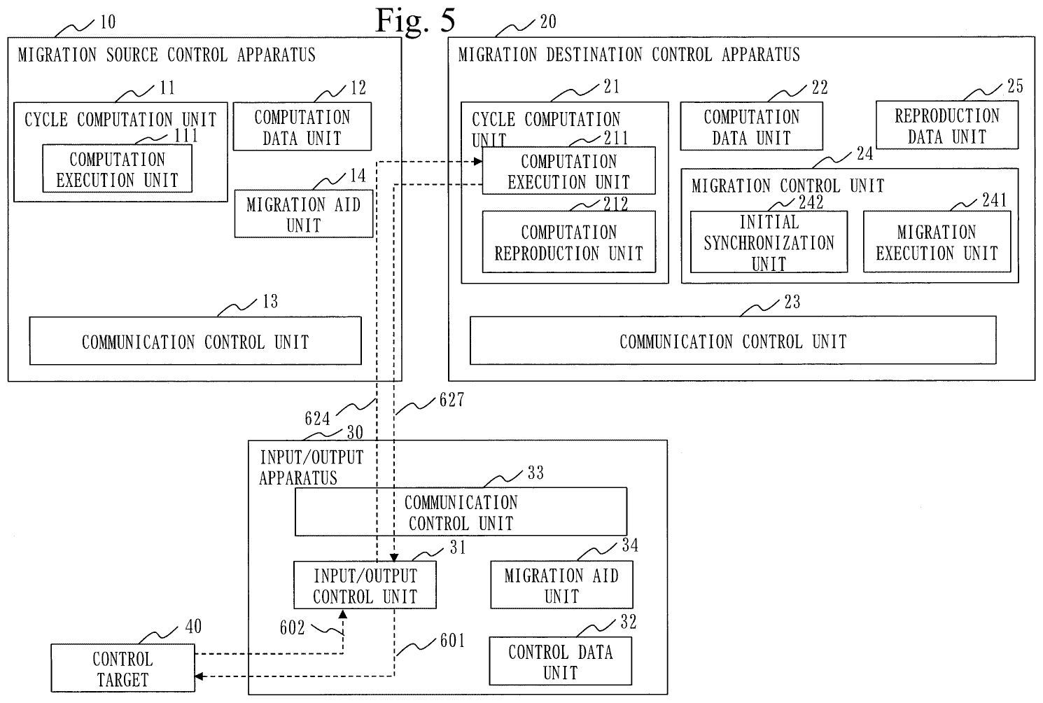

The state after completion of migration is a state in which the migration destination control apparatus 20 cooperatively operates with the input/output apparatus 30 through the network 91 to control the control target 40. FIG. 5 illustrates a data flow of the state after completion of migration.

The state during migration is classified into a state during initial synchronization, a state during reproduction computation, and a state during switching control.

The state during initial synchronization is a state from a process start of a migration execution unit 241 to be described later to a process end of an initial synchronization unit 242 to be described later. The state during reproduction computation is a state from when the state during initial synchronization is completed to a process end of a computation reproduction unit 212 to be described later. The state during switching control is a state from when the state during reproduction computation is completed to a process end of the migration execution unit 241 to be described later.

### Functions of Control Migration System 100

Functions of each apparatus, the migration source control apparatus 10, the migration destination control apparatus 20, and the input/output apparatus 30 that the control migration system 100 includes, will be described.

In each apparatus, an operating system or a hypervisor to manage execution of functions installed in the apparatus may be included in addition to functional elements described below.

A means of notification or state confirmation between functions in a same apparatus may be any means. For example, the notification or the state confirmation between the functions in the same apparatus is enabled using a shared memory, an inter-task communication function that the operating system provides, or the like.

Execution timing or core allocation in a processor is controlled for the functions in each apparatus so as to satisfy condition 1 and condition 2 below. Condition 1 is a condition of which a computation execution unit 111 (or a computation execution unit 211) to be described later can receive measurement value information 621 (or measurement value information 624) once within a computation cycle T_cyc[ms]. Condition 2 is a condition of which an input/output control unit 31 can receive computation result information 622 (or computation result information 627) once within the computation cycle T_cyc[ms].

### Functions of Migration Source Control Apparatus 10

The migration source control apparatus 10 includes a cycle computation unit 11, a computation data unit 12, a communication control unit 13, and a migration aid unit 14 as functional elements.

The cycle computation unit 11 performs one execution unit's worth of computation process in the computation cycle T_cyc[ms]. The computation process, as a specific example, is a task or a set of tasks that is controlled by a cycle handler or the operating system. In a case where the computation process is a process that operates on a virtual machine, the cycle computation unit 11 uses the virtual machine.

Specifically, the computation execution unit 111 that the cycle computation unit 11 includes executes a computation with the measurement value information 621 received from the input/output apparatus 30 and information of the computation data unit 12 as input, and generates the computation result information 622 in a cycle of the computation cycle T_cyc[ms]. The computation execution unit 111 transmits the computation result information 622 to the input/output apparatus 30. The computation execution unit 111 performs an update of some content of the computation data unit 12 during execution of the computation process.

The measurement value information 621 includes a measurement value and a measurement number of a control data unit 32. The computation result information 622 includes a computation result. The computation result information 622 may further include a computation number of the computation data unit 12.

The computation data unit 12 manages data that is necessary for the computation process of the cycle computation unit 11 and data that is necessary for execution management of the computation process. In Embodiment 1, the computation data unit 12 manages a measurement number used, the computation number, a start timestamp, an end timestamp, and internal data.

The measurement number used is a measurement number included in the measurement value information 621 that is used in a most recent computation. The computation number is a number that increases incrementally for every computation. The start timestamp is a value of a synchronization time counter when the cyclic computation process of the cycle computation unit 11 is started up or when a standby state has been exited. The end timestamp is a value of the synchronization time counter when the cyclic computation process of the cycle computation unit 11 entered the standby state. The internal data is data that is necessary to be retained internally for the computation process. The internal data also includes a computation result that is generated.

The communication control unit 13 performs transmission and reception of information to and from a function in a different apparatus. The communication control unit 13 buffers information received from the network 91, and makes a different function in the apparatus obtain the information. The communication control unit 13 buffers information that is requested to be transmitted by a different function in the apparatus, and transmits the information to the network 91 at specific timing.

Real-time performance is required for communication of the measurement value information 621, the computation result information 622, and the like. Consequently, as for these pieces of data, the communication control unit 13 adjusts transmission timing in a way that the real-time performance is guaranteed. For example, a communication system that conforms to IEEE802.1TSN standard is adopted, and control is done in a way that transmission and reception of these pieces of data are completed within a certain amount of time. TSN is an abbreviation for Time Sensitive Networking.

The communication control unit 13 includes a time synchronization function to synchronize time between apparatuses. This function, for example, is enabled based on a highly accurate time synchronization system such as IEEE802.1AS that is a part of the IEEE802.1TSN standard, IEEE1588, or the like. A result by the time synchronization function is reflected in a synchronization time counter that is built in the communication control unit 13.

The migration aid unit 14 aids a migration execution unit 241 and an initial synchronization unit 242 in a migration control unit 24 that the migration destination control apparatus 20 includes.

In a case where an initial synchronization request 625 is received from the initial synchronization unit 242, the migration aid unit 14 generates and transmits initial synchronization information 626 to the initial synchronization unit 242. The initial synchronization information 626 is information that necessitates synchronization among content of the computation data unit 12 at computation execution time of a computation number (called a starting point computation number) in a specified cycle that relates to the computation execution unit 111 of the cycle computation unit 11. The initial synchronization information 626 always includes the measurement number used, the computation number, the start timestamp, and the end timestamp. The initial synchronization information 626 includes the internal data, but as for the internal data, in a case where unnecessary data is included, the unnecessary data does not need to be included.

The migration aid unit 14 stops the cycle computation unit 11 when a condition of the switching timing information 629 is met after receiving switching timing information 629 from the migration execution unit 241. After that, the migration aid unit 14 transmits switching completion 6211 to the migration execution unit 241. The switching timing information 629 is information that indicates a condition for switching from the migration source control apparatus 10 to the migration destination control apparatus 20. A condition is defined for the switching timing information 629 based on information in the migration source control apparatus 10. This condition, as a specific example, is “when the value of the synchronization time counter becomes more than or equal to a certain value”, “when the computation number in the computation data unit 12 becomes more than or equal to a certain value”, or the like.

### Functions of Migration Destination Control Apparatus 20

The migration destination control apparatus 20 includes the cycle computation unit 21, a computation data unit 22, a communication control unit 23, the migration control unit 24, and a reproduction data unit 25 as functional elements.

The computation data unit 22 and the communication control unit 23 are same as the computation data unit 12 and the communication control unit 13 of the migration source control apparatus 10.

The cycle computation unit 21 includes the computation execution unit 211 and the computation reproduction unit 212. The computation execution unit 211 is a same as the computation execution unit 111 that the cycle computation unit 11 of the migration source control apparatus 10 includes.

After a process of the initial synchronization unit 242 ends, the computation reproduction unit 212 executes reproduction computation to reproduce computation executed in the computation execution unit 111 of the cycle computation unit 11 based on content of the computation data unit 22 and the reproduction data unit 25. Thus, the computation reproduction unit 212 synchronizes information that necessitates synchronization in the computation data unit 22 with the information of the computation data unit 12.

The computation reproduction unit 212 transmits a measurement value information request 623 to a migration aid unit 34, and every time the measurement value information 624 is received, saves the measurement value information 624 in a measurement value information buffer in the reproduction data unit 25.

The migration control unit 24 is responsible for controlling migration. The migration control unit 24 includes the migration execution unit 241 and the initial synchronization unit 242.

The migration execution unit 241 is responsible for overall execution of the migration. The migration execution unit 241 starts execution of the initial synchronization unit 242 and the cycle computation unit 21. After a process of the computation reproduction unit 212 ends, the migration execution unit 241 stands by until receiving switching preparation completion 628 from the migration aid unit 34. After that, the migration execution unit 241, along with generating and transmitting the switching timing information 629 to the migration aid unit 14, generates and transmits switching timing information 6210 to the migration aid unit 34. In a case where, along with receiving the switching completion 6211 from the migration aid unit 14, switching completion 6212 is received from the migration aid unit 34, the migration execution unit 241 ends the migration.

In a case where the computation reproduction unit 212 started first reception of the measurement value information 624, the initial synchronization unit 242 transmits the initial synchronization request 625 to the migration aid unit 14. The initial synchronization unit 242 receives the initial synchronization information 626 as a response to the initial synchronization request 625. The initial synchronization unit 242 stores the initial synchronization information 626 in the computation data unit 22. The initial synchronization unit 242 reflects a part of the initial synchronization information 626 in the starting point computation number, a starting point start timestamp, and a starting point end timestamp that the reproduction data unit 25 manages.

The reproduction data unit 25 manages information that is necessary for reproduction of the computation executed in the computation execution unit 111. In Embodiment 1, the reproduction data unit 25 manages the measurement value information buffer, the starting point computation number, the starting point start timestamp, the starting point end timestamp, and a deduced migration source computation number.

The measurement value information that the computation reproduction unit 212 received is set in the measurement value information buffer. The computation number in the initial synchronization information 626 that the initial synchronization unit 242 received is set to the starting point computation number. The start timestamp in the initial synchronization information 626 that the initial synchronization unit 242 received is set to the starting point start timestamp. The end timestamp in the initial synchronization information 626 that the initial synchronization unit 242 received is set to the starting point end timestamp. A computation number of the computation data unit 12 that is set in a current computation cycle that the computation reproduction unit 212 deduced is set to the deduced migration source computation number.

### Functions of Input/Output Apparatus 30

The input/output apparatus 30 includes the input/output control unit 31, the control data unit 32, a communication control unit 33, and the migration aid unit 34 as functional elements.

The communication control unit 33 is a same as the communication control unit 13 of the migration source control apparatus 10.

The input/output control unit 31 updates content of the control data unit 32 based on a measurement value 601. The input/output control unit 31 generates the measurement value information 621 or the measurement value information 624 based on the measurement value 601, and transmits the measurement value information 621 or the measurement value information 624 to one of control apparatuses, the migration source control apparatus 10 and the migration destination control apparatus 20, that is designated as a communication destination.

The input/output control unit 31 extracts a computation result 602 from the computation result information 622 or the computation result information 627 that is received from the control apparatus that is designated as the communication destination and outputs the computation result 602 to the control target 40. In a case where a state is in which both the computation result information 622 and the computation result information 627 can be received, either one may be used. The control apparatus that is to be the communication destination is set externally. In Embodiment 1, the control apparatus that is to be the communication destination is set by the migration aid unit 34.

The control data unit 32 manages data that is necessary for an input/output control process of the input/output control unit 31, and data that is necessary for execution management of the input/output control process. In Embodiment 1, the control data unit 32 at least manages a measurement number. The control data unit 32 may manage other necessary internal data.

The measurement number is a number that incrementally increases every time the measurement value 601 is inputted.

The migration aid unit 34 aids operation of the migration execution unit 241.

In a case where the measurement value information request 623 is received from the computation reproduction unit 212, the migration aid unit 34 sets the migration destination control apparatus 20 as a communication destination of the input/output control unit 31.

In a case where the input/output control unit 31 started reception of the computation result information 627, the migration aid unit 34 transmits the switching preparation completion 628 to the migration execution unit 241.

The migration aid unit 34 deletes the migration source control apparatus 10 from the communication destination of the input/output control unit 31 when a condition of the switching timing information 6210 is met after receiving the switching timing information 6210 from the migration execution unit 241. Then, the migration aid unit 34 transmits the switching completion 6212 to the migration execution unit 241.

Here, the switching timing information 6210 is information that indicates a condition for switching from the migration source control apparatus 10 to the migration destination control apparatus 20. A condition is defined for the switching timing information 6210 based on information in the input/output apparatus 30. This condition, as a specific example, is “when the value of the synchronization time counter becomes more than or equal to a certain value”, “when the measurement number in the control data unit 32 becomes more than or equal to a certain value”, or the like.

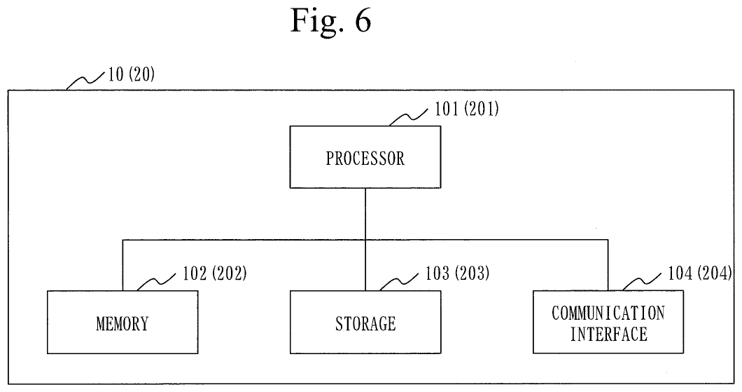

Hardware configurations of the migration source control apparatus 10 and the migration destination control apparatus 20 according to Embodiment 1 will be described by referring to FIG. 6.

The migration source control apparatus 10 and the migration destination control apparatus 20 are computers.

The migration source control apparatus 10 includes hardware such as a processor 101, a memory 102, storage 103, and a communication interface 104. The processor 101 is connected to other pieces of hardware through a signal line and controls these other pieces of hardware.

The migration destination control apparatus 20 includes hardware such as a processor 201, a memory 202, storage 203, and a communication interface 204. The processor 201 is connected to other pieces of hardware through a signal line and controls these other pieces of hardware.

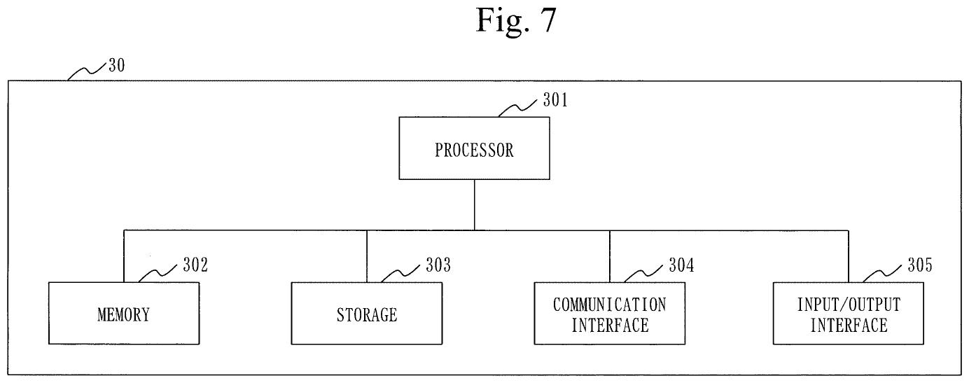

A hardware configuration of the input/output apparatus 30 according to Embodiment 1 will be described by referring to FIG. 7.

The input/output apparatus 30 is a computer.

The input/output apparatus 30 includes hardware such as a processor 301, a memory 302, storage 303, a communication interface 304, and an input/output interface 305. The processor 301 is connected to other pieces of hardware through a signal line and controls these other pieces of hardware.

The processors 101, 201, and 301 are ICs that perform processing. IC is an abbreviation for Integrated Circuit. The processors 101, 201, and 301, as specific examples, are CPUs, DSPs, and GPUs. CPU is an abbreviation for Central Processing Unit. DSP is an abbreviation for Digital Signal Processor. GPU is an abbreviation for Graphics Processing Unit.

The memories 102, 202, and 302 are storage apparatuses that store data temporarily. The memories 102, 202, and 302, as specific examples, are SRAMs and DRAMs. SRAM is an abbreviation for Static Random Access Memory. DRAM is an abbreviation for Dynamic Random Access Memory.

The storage 103, 203, and 303 are storage apparatuses that keep data. The storage 103, 203, and 303, as specific examples, are HDDs. HDD is an abbreviation for Hard Disk Drive. The storage 103, 203, and 303 may also be portable storage media such as SD (registered trademark) memory cards, CompactFlash (registered trademark), NAND flash, flexible disks, optical discs, compact discs, Blu-ray (registered trademark) discs, and DVDs. SD is an abbreviation for Secure Digital. DVD is an abbreviation for Digital Versatile Disk.

The communication interfaces 104, 204, and 304 are interfaces to communicate with an external apparatus through the network 91. The communication interfaces 104, 204, and 304, as specific examples, are ports of Ethernet (registered trademark).

The input/output interface 305 is an interface to perform input/output to/from the outside through the transmission channel 92. The input/output interface 305, as a specific example, is a port of a USB or an HDMI (registered trademark). USB is an abbreviation for Universal Serial Bus. HDMI is an abbreviation for High-Definition Multimedia Interface.

Functions of each functional element of the migration source control apparatus 10 are enabled by software. A program that enables the functions of each functional element of the migration source control apparatus 10 is saved in the storage 103. This program is read into the memory 102 by the processor 101 and executed by the processor 101. Thus, the functions of each functional element of the migration source control apparatus 10 are enabled.

Similarly, functions of each functional element of the migration destination control apparatus 20 are enabled by software. A program that enables the functions of each functional element of the migration destination control apparatus 20 is saved in the storage 203. This program is read into the memory 202 by the processor 201 and executed by the processor 201. Thus, the functions of each functional element of the migration destination control apparatus 20 are enabled.

Similarly, functions of each functional element of the input/output apparatus 30 are enabled by software. A program that enables the functions of each functional element of the input/output apparatus 30 is saved in the storage 303. This program is read into the memory 302 by the processor 301 and executed by the processor 301. Thus, the functions of each functional element of the input/output apparatus 30 are enabled.

Functions of the communication control unit 13 are enabled utilizing the communication interface 104. Similarly, functions of the communication control unit 23 are enabled utilizing the communication interface 204. Similarly, functions of the communication control unit 33 are enabled utilizing the communication interface 304. The computation data unit 12 manages data using the memory 102. Similarly, the computation data unit 22 and the reproduction data unit 25 manage data using the memory 202. Similarly, the control data unit 32 manages data using the memory 302. The input/output control unit 31 accepts input of the measurement value 601 through the input/output interface 305, and outputs the computation result 602.

### Description of Operation

Operation of the control migration system 100 according to Embodiment 1 will be described.

Operation procedure of the control migration system 100 according to Embodiment 1 is equivalent to a control migration method according to Embodiment 1. A program that enables the operation of the control migration system 100 according to Embodiment 1 is equivalent to a control migration program according to Embodiment 1.

As mentioned above, the control migration system 100 has three states, the state before start of migration, the state during migration, and the state after completion of migration. Here, the operation will be described separately for the state before start of migration, the state during migration, and the state after completion of migration.

### State Before Start of Migration

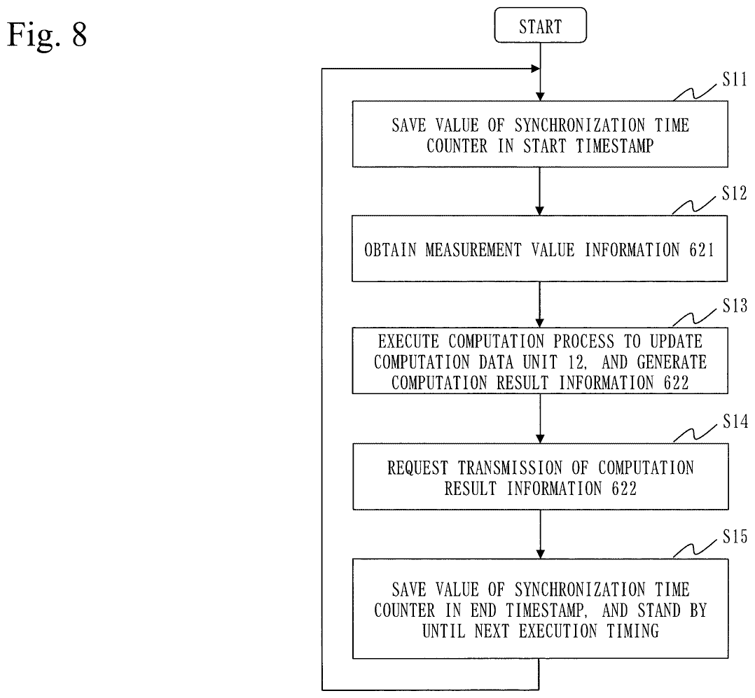

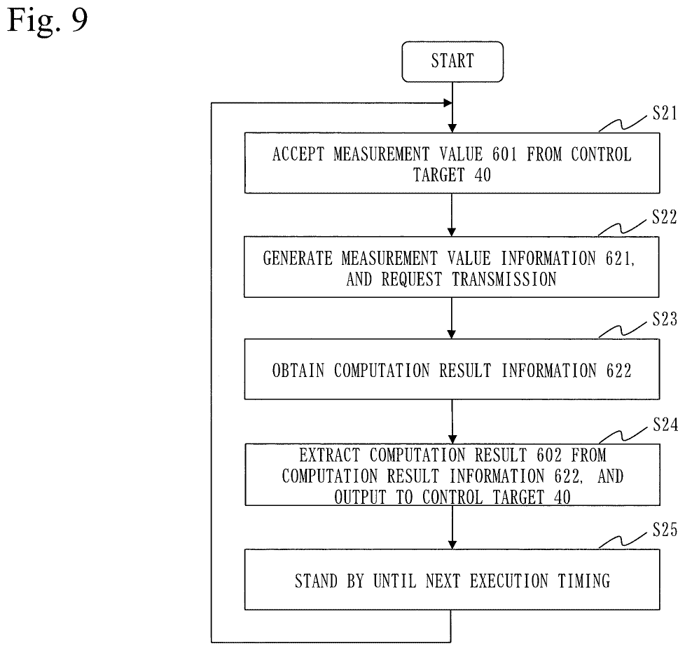

Operation of the control migration system 100 in the state before start of migration according to Embodiment 1 will be described by referring to FIG. 2, FIG. 8, and FIG. 9.

The state before start of migration is a state in which the migration source control apparatus 10 cooperatively operates with the input/output apparatus 30 through the network 91 to control the control target 40. At this time, in the migration source control apparatus 10, the computation execution unit 111 executes a computation process, and the control target 40 is controlled based on a computation result of the computation process. At this time, the migration source control apparatus 10 is set to the communication destination of the input/output control unit 31.

Operation of the computation execution unit 111 of the migration source control apparatus 10 according to Embodiment 1 will be described by referring to FIG. 2 and FIG. 8.

In step S11, the computation execution unit 111 obtains a value of the synchronization time counter of the communication control unit 13 and saves the value in the start timestamp in the computation data unit 12.

In step S12, the computation execution unit 111 obtains measurement value information 621 that the communication control unit 13 received.

In step S13, the computation execution unit 111 executes a computation process based on the measurement value information 621 obtained in step S12 and content of the internal data of the computation data unit 12 to update the measurement number used, the computation number, and the internal data that the computation data unit 12 manages, and generates the computation result information 622.

In step S14, the computation execution unit 111 notifies the communication control unit 13 of a transmission request to the input/output control unit 31 of the computation result information 622 that is generated in step S13.

In step S15, the computation execution unit 111 obtains the value of the synchronization time counter of the communication control unit 13, and saves the value in the end timestamp of the computation data unit 12. Then, the computation execution unit 111 stands by until next execution timing. Here, the next execution timing is time when the computation cycle T_cyc[ms] has elapsed from startup time of this time. A standby method can be any method, and for example, calculating standby time until a next startup using the start timestamp or the end timestamp and standing by for that time can be considered.

Operation of the input/output control unit 31 of the input/output apparatus 30 according to Embodiment 1 will be described by referring to FIG. 2 and FIG. 9. In step S21, the input/output control unit 31 accepts the input of the measurement value 601 from the control target 40 through the input/output interface 305.

In step S22, the input/output control unit 31 updates the measurement number that the control data unit 32 manages, and generates the measurement value information 621. Then, the input/output control unit 31 notifies the communication control unit 33 of a transmission request to transmit the measurement value information 621 to the migration source control apparatus 10 that is the control apparatus that is designated as the communication destination.

In step S23, the input/output control unit 31 obtains from the communication control unit 33, the computation result information 622 that is received from the migration source control apparatus 10 that is the control apparatus that is designated as the communication destination.

In step S24, the input/output control unit 31 extracts the computation result 602 from the computation result information 622 that is obtained in step S23. Then, the input/output control unit 31 outputs the computation result 602 to the control target 40 through the input/output interface 305.

In step S25, the input/output control unit 31 stands by until next execution timing.

### State During Migration

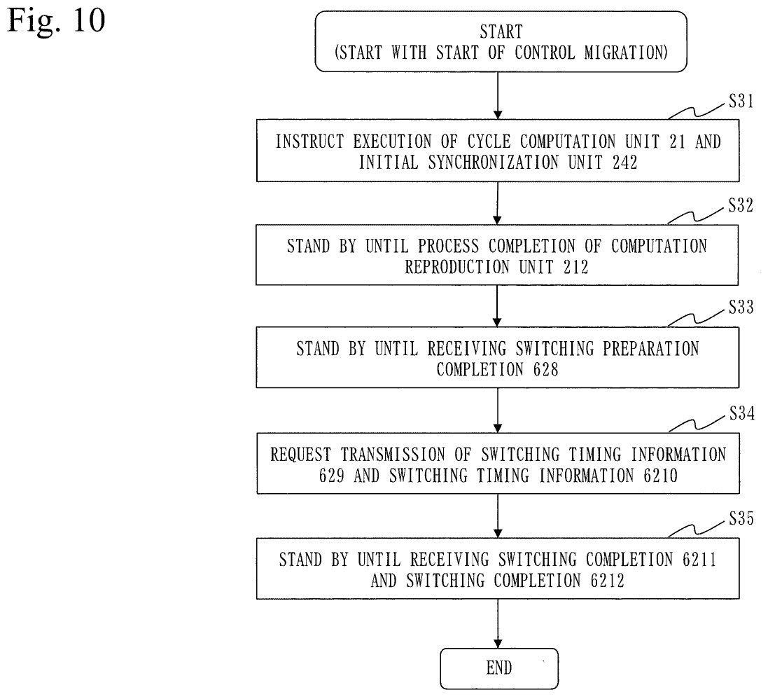

Operation of the control migration system 100 in the state during migration according to Embodiment 1 will be described by referring to FIG. 3 and FIG. 4, and FIG. 10 to FIG. 15.

The state during migration is a state in which the information in the migration source control apparatus 10 that is necessary to be synchronized is synchronized with the migration destination control apparatus 20, and the control apparatus that the input/output apparatus 30 cooperatively operates with is being switched from the migration source control apparatus 10 to the migration destination control apparatus 20. In the state during migration, the state is continued in which, in the state before start of migration, the migration source control apparatus 10 cooperatively operates with the input/output apparatus 30 through the network 91 to control the control target 40. In the final stage of the state during migration, the state in which, in the state before start of migration, the migration source control apparatus 10 cooperatively operates with the input/output apparatus 30 through the network 91 to control the control target 40 is in a continued state is switched to the state in which the migration destination control apparatus 20 cooperatively operates with the input/output apparatus 30 through the network 91 to control the control target 40.

The state during migration is classified into the state during initial synchronization, the state during reproduction computation, and the state during switching control. Here, the operation will be described separately for the state during initial synchronization, the state during reproduction computation, and the state during switching control.

### State During Initial Synchronization

The state during initial synchronization is the state from the process start of the migration execution unit 241 to the process end of the initial synchronization unit 242.

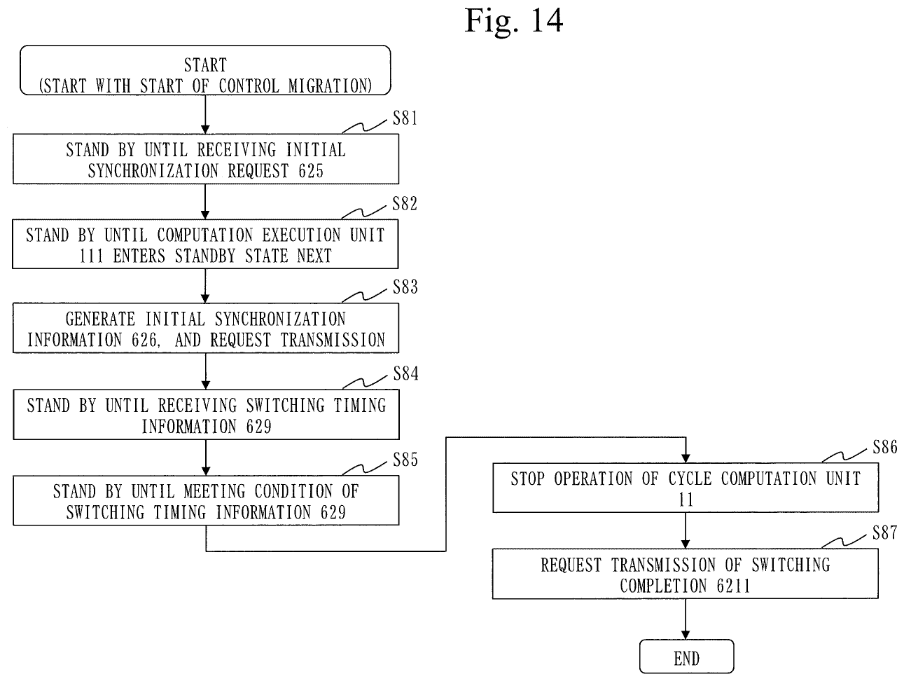

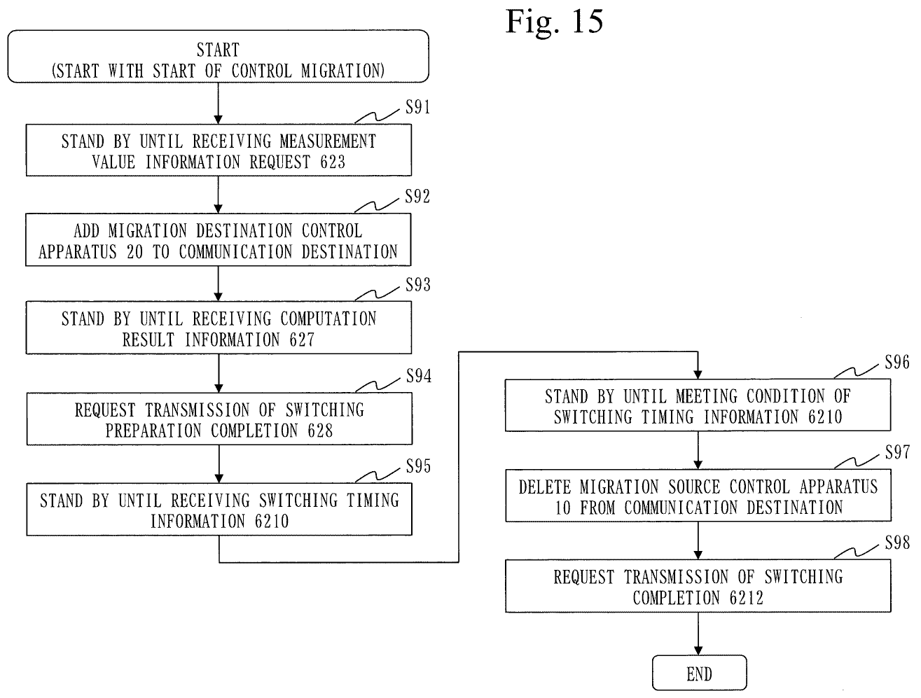

When control migration is started, an operation flow of the migration execution unit 241 of the migration destination control apparatus 20 (refer to FIG. 10) is started. An operation flow of the migration aid unit 14 of the migration source control apparatus 10 (refer to FIG. 14) is started. An operation flow of the migration aid unit 34 of the input/output apparatus 30 (refer to FIG. 15) is started.

The operation of the migration execution unit 241 according to Embodiment 1 will be described by referring to FIG. 10.

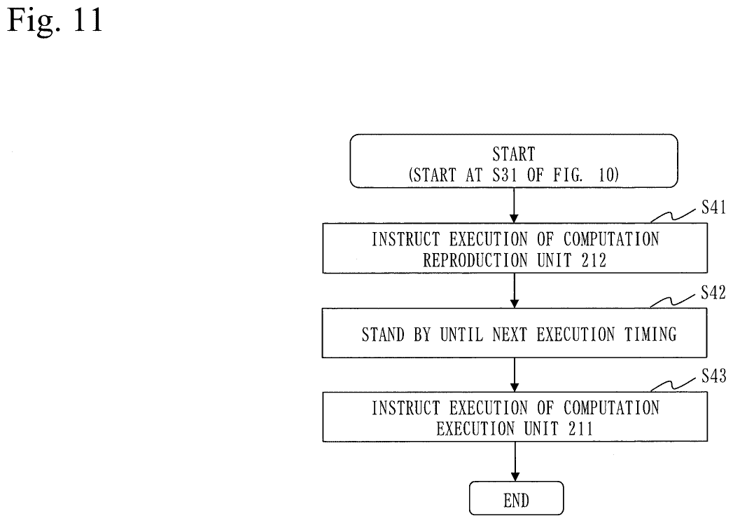

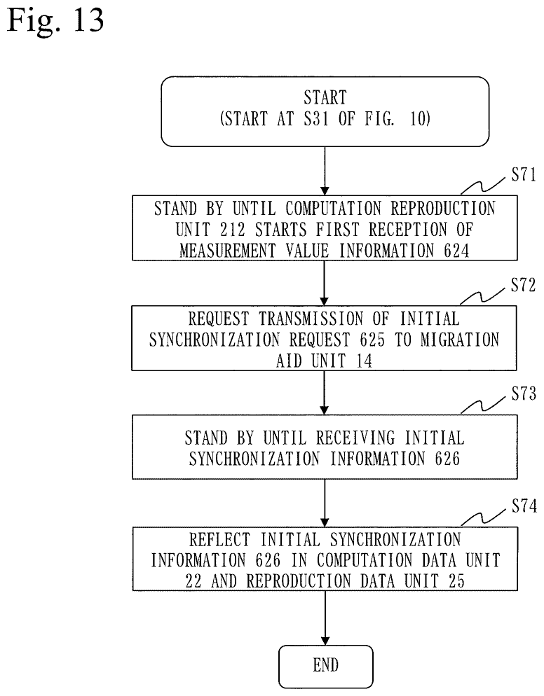

In step S31, the migration execution unit 241 instructs execution of an operation flow of the cycle computation unit 21 (refer to FIG. 11) and an operation flow of the initial synchronization unit 242 (refer to FIG. 13). The operation flow of the cycle computation unit 21 and the operation flow of the initial synchronization unit 242 are executed in parallel. For example, the operation flow of the cycle computation unit 21 and the operation flow of the initial synchronization unit 242 are executed in separate tasks.

In step S32, the migration execution unit 241 stands by until the process of the computation reproduction unit 212 of the cycle computation unit 21 is completed. This standby state is exited in the state during switching control. Consequently, processes of step S33 and onwards will be described later.

Operation of the cycle computation unit 21 according to Embodiment 1 will be described by referring to FIG. 11.

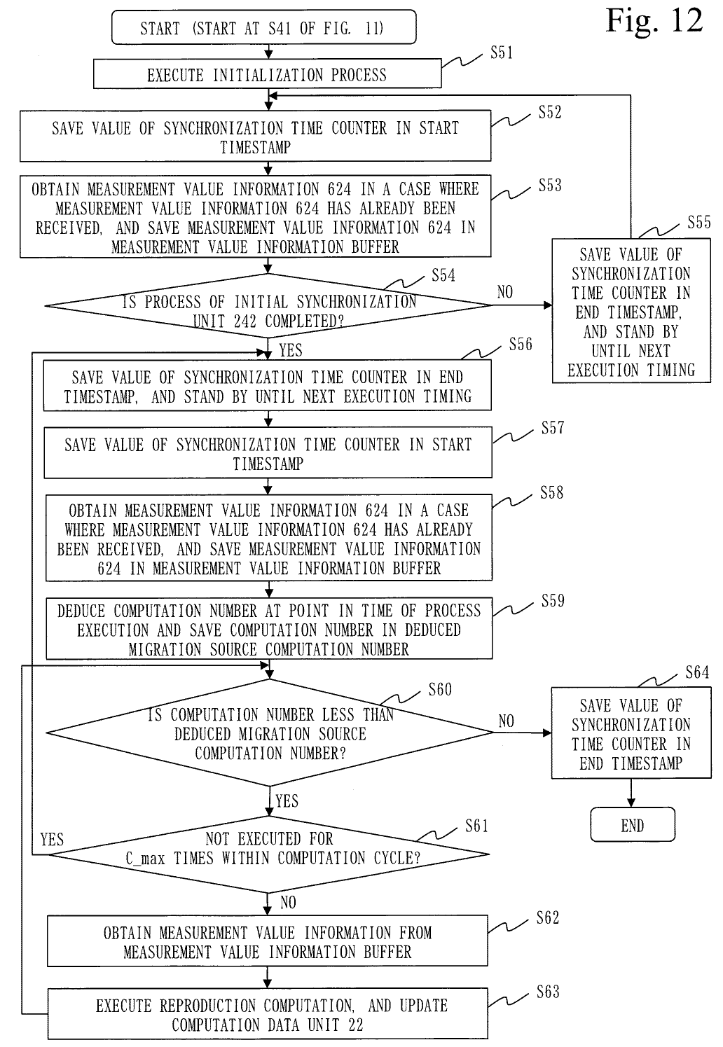

In step S41, the cycle computation unit 21 instructs execution of an operation flow of the computation reproduction unit 212 (refer to FIG. 12). Since step S42 is executed after the operation flow of the computation reproduction unit 212 ends, processes of step S42 and onwards will be described later.

Operation of the computation reproduction unit 212 according to Embodiment 1 will be described by referring to FIG. 3 and FIG. 12.

In step S51, the computation reproduction unit 212 executes an initialization process that is necessary for initialization of the cycle computation unit 21. Specifically, the computation reproduction unit 212 initializes a part that is not a synchronization target of the initial synchronization unit 242 of internal data that the computation data unit 22 manages. The computation reproduction unit 212 matches a phase where the computation cycle T_cyc[ms] is started up with a phase of the cycle computation unit 11 of the migration source control apparatus 10. The computation reproduction unit 212 notifies the communication control unit 23 of a transmission request of the measurement value information request 623 to the migration aid unit 34 of the input/output apparatus 30.

In step S52, the computation reproduction unit 212 obtains a value of the synchronization time counter from the communication control unit 23, and saves the value in a start timestamp that the computation data unit 22 manages.

In step S53, in a case where the communication control unit 23 has already received the measurement value information 624, the computation reproduction unit 212 obtains the measurement value information 624. Then, the computation reproduction unit 212 saves the measurement value information 624 in the measurement value information buffer that the reproduction data unit 25 manages.

In step S54, in a case where the operation flow of the initial synchronization unit 242 (refer to FIG. 13) is completed, the computation reproduction unit 212 proceeds with the process to step S56. On the other hand, in a case where the operation flow of the initial synchronization unit 242 (refer to FIG. 13) is not completed, the computation reproduction unit 212 proceeds with the process to step S55.

In step S55, the computation reproduction unit 212 obtains the value of the synchronization time counter from the communication control unit 23, and saves the value in the end timestamp of the computation data unit 22. Then, the computation reproduction unit 212 returns the process to step S52 after standing by until next execution timing of the cycle computation unit 21.

When the operation flow of the initial synchronization unit 242 ends, the state during initial synchronization ends. Therefore, processes of step S56 and onwards will be described later.

Operation of the initial synchronization unit 242 according to Embodiment 1 will be described by referring to FIG. 3 and FIG. 13.

In step S71, the initial synchronization unit 242 stands by until the computation reproduction unit 212 starts first reception of the measurement value information 624 in step S53 of FIG. 12.

In step S72, the initial synchronization unit 242 notifies the communication control unit 23 of a transmission request of the initial synchronization request 625 to the migration aid unit 14 of the migration source control apparatus 10.

In step S73, the initial synchronization unit 242 stands by until the communication control unit 23 receives the initial synchronization information 626 from the migration aid unit 14 of the migration source control apparatus 10.

In step S74, the initial synchronization unit 242 obtains the initial synchronization information 626 from the communication control unit 23. Then, the initial synchronization unit 242 reflects the information of the initial synchronization information 626 in the computation data unit 22 and the reproduction data unit 25, and ends the process.

Here, the initial synchronization information 626 is the information that necessitates synchronization among content of the computation data unit 12 at the computation execution time of the computation number (called the starting point computation number) in the specified cycle that relates to the computation execution unit 111. Here, the initial synchronization information 626 includes the measurement number used, the computation number, the start timestamp, and the end timestamp. The initial synchronization information 626 may include the internal data.

Operation of the migration aid unit 14 according to Embodiment 1 will be described by referring to FIG. 3 and FIG. 14.

In step S81, the migration aid unit 14 stands by until the communication control unit 13 receives the initial synchronization request 625 from the initial synchronization unit 242. The migration aid unit 14 obtains the initial synchronization request 625 when the communication control unit 13 receives the initial synchronization request 625.

In step S82, the migration aid unit 14 stands by until the computation execution unit 111 of the cycle computation unit 11 enters a standby state next.

In step S83, the migration aid unit 14 generates the initial synchronization information 626 with the computation cycle at a point in time when the process is being executed as a specified cycle. Then, the migration aid unit 14 notifies the communication control unit 13 of a transmission request of the initial synchronization information 626 to the initial synchronization unit 242.

In step S84, the migration aid unit 14 stands by until the communication control unit 13 receives the switching timing information 629 from the migration execution unit 241. The migration aid unit 14 obtains the switching timing information 629 when the communication control unit 13 receives the switching timing information 629. Since reception of the switching timing information 629 is done in the state during switching control, processes of step S85 and onwards will be described later.

Operation of the migration aid unit 34 according to Embodiment 1 will be described by referring to FIG. 3 and FIG. 15.

In step S91, the migration aid unit 34 stands by until the communication control unit 33 receives the measurement value information request 623 from the computation reproduction unit 212. The migration aid unit 34 obtains the measurement value information request 623 when the communication control unit 33 receives the measurement value information request 623.

In step S92, the migration aid unit 34 adds the migration destination control apparatus 20 to the communication destination of the input/output control unit 31. Thus, the input/output control unit 31 begins to perform notification of a transmission request of the measurement value information 624 and obtaining of the computation result information 627.

In step S93, the migration aid unit 34 stands by until the communication control unit 33 starts the reception of the computation result information 627 from the computation execution unit 211 of the migration destination control apparatus 20. Since the reception of the computation result information 627 is performed in the state during switching control, processes of step S94 and onwards will be described later.

### State During Reproduction Computation

The state during reproduction computation is a state from when the state during initial synchronization is completed to the process end of the computation reproduction unit 212.

When the operation flow of the initial synchronization unit 242 illustrated in FIG. 13 ends, the state during initial synchronization ends. Then, the process proceeds from step S54 to step S56 of FIG. 12.

The operation of the computation reproduction unit 212 will be described by referring to FIG. 3 and FIG. 12.

In step S56, the computation reproduction unit 212 obtains the value of the synchronization time counter from the communication control unit 23, and saves the value in an end timestamp that the computation data unit 22 manages. Then, the computation reproduction unit 212 stands by until next execution timing. Here, the next execution timing is the time when the computation cycle T_cyc[ms] has elapsed from the startup time of this time.

In step S57, the computation reproduction unit 212 obtains the value of the synchronization time counter from the communication control unit 23, and saves the value in the start timestamp that the computation data unit 22 manages.

In step S58, in a case where the communication control unit 23 has already received the measurement value information 624, the computation reproduction unit 212 obtains the measurement value information 624. Then, the computation reproduction unit 212 saves the measurement value information 624 in the measurement value information buffer that the reproduction data unit 25 manages.

In step S59, the computation reproduction unit 212 deduces a computation number of the computation execution unit 111 of the migration source control apparatus 10 in a computation cycle of a point in time when the process is being executed. Then, the computation reproduction unit 212 saves the computation number that is deduced in the deduced migration source computation number that the reproduction data unit 25 manages.

The computation reproduction unit 212 deduces the computation number of the computation execution unit 111 by a procedure below.

First, the computation reproduction unit 212 obtains the synchronization time counter from the communication control unit 23. The computation reproduction unit 212 calculates elapsed time since the computation execution unit 111 executed a computation indicated by the starting point computation number that the reproduction data unit 25 manages based on a difference between the synchronization time counter and a value of the starting point start timestamp or a value of the starting point end timestamp that the reproduction data unit 25 manages. In other words, the computation reproduction unit 212 calculates the elapsed time from a start or an end time of a computation process in the specified cycle to time when a process is currently being executed. A computation cycle where the process is currently being executed is set to a migration cycle at this time.

The computation reproduction unit 212 deduces the number of execution of a computation process that is executed or to be executed by the computation execution unit 111 from a next computation cycle after the specified cycle to the computation cycle where the process is currently being executed based on the elapsed time that is calculated and the computation cycle T_cyc[ms]. The computation reproduction unit 212 deduces a value of the number of execution and the starting point computation number added, the starting point computation number that is managed by the reproduction data unit 25, as a computation number of the computation execution unit 111 in the computation cycle where the process is being executed.

Once a value has already been set to the deduced migration source computation number, a deduction of the computation number is executed for every computation cycle T_cyc[ms] onwards. Therefore, instead of the process mentioned above, the computation reproduction unit 212 may deduce a value that is one added to a value of a current deduced migration source computation number as the computation number of the computation execution unit 111 in the computation cycle where the process is being executed.

In step S60, the computation reproduction unit 212 verifies whether or not a value of a computation number that the computation data unit 22 manages is less than the value of the deduced migration source computation number that the reproduction data unit 25 manages. In a case where the value of the computation number is less than the value of the deduced migration source computation number, the computation reproduction unit 212 proceeds with the process to step S61. On the other hand, in a case where the value of the computation number is not less than the value of the deduced migration source computation number, the computation reproduction unit 212 proceeds with the process to step S64. In step S64, the computation reproduction unit 212 obtains the value of the synchronization time counter, saves the value in the end timestamp that the computation data unit 22 manages, and ends the process.

In step S61, in a case where processes of step S62 and step S63 have not been executed for the limited number of times C_max times within the computation cycle T_cyc[ms], the computation reproduction unit 212 proceeds with the process to step S62. On the other hand, in a case where the processes are executed the limited number of times C_max times, the computation reproduction unit 212 returns the process to step S56.

Here, the limited number of times C_max is a natural number that is decided on within a range that satisfies d[ms]*C_max<=D_max when a maximum value of a total value of processing time from step S60 to step S63 and margin time is d[ms]. D_max[ms] is maximum time in which a process of the cycle computation unit 21 can be executed with priority over a different process until next execution timing of the computation process, and is ensured in a way that at least C_max>=2.

In step S62, the computation reproduction unit 212 obtains measurement value information that includes a same number as a value of which one is added to a measurement number used that the computation data unit 22 manages from the measurement value information buffer that the reproduction data unit 25 manages.

In step S63, the computation reproduction unit 212 executes the reproduction computation based on the measurement value information obtained in step S62 and content of the internal data that the computation data unit 22 manages. The reproduction computation is a computation in which the computation process by the computation execution unit 111 is reproduced. The computation reproduction unit 212 generates a computation result of the reproduction computation, and updates the measurement number used, the computation number, and the content of the internal data that the computation data unit 22 manages.

### State During Switching Control

The state during switching control is a state from when the state during reproduction computation is completed to the process end of the migration execution unit 241.

When the operation flow of the computation reproduction unit 212 illustrated in FIG. 12 ends, a process of step S42 of FIG. 11 is started. The standby state of step S32 of FIG. 10 is exited and a process of step S33 is started.

Operation of the cycle computation unit 21 will be described by referring to FIG. 4 and FIG. 11.

In step S42, the cycle computation unit 21 proceeds with the process to step S43 after standing by until next execution timing.

In step S43, the cycle computation unit 21 causes the computation execution unit 211 to start the computation process. Thus, transmission of the computation result information 627 from the computation execution unit 211 to the input/output apparatus 30 is started. And, the control target 40 will be able to be controlled using a result of the computation process that is executed by the computation execution unit 211. In other words, after a migration cycle that is set last in step S59 of FIG. 12, the control target 40 will be able to be controlled using the result of the computation process that is executed by the computation execution unit 211.

In principle, an operation flow and a description of the computation execution unit 211, and an operation flow and the description of the computation execution unit 111 illustrated in FIG. 8 are same. Wording in the description, however, is necessary to be replaced from wording of the migration source control apparatus 10 to wording of the migration destination control apparatus 20.

The operation of the migration execution unit 241 will be described by referring to FIG. 4 and FIG. 10.

In step S33, the migration execution unit 241 stands by until the communication control unit 23 receives the switching preparation completion 628 from the migration aid unit 34. In a case where the communication control unit 23 received the switching preparation completion 628, the migration execution unit 241 obtains the switching preparation completion 628.

In step S34, the migration execution unit 241 generates the switching timing information 629 and the switching timing information 6210. Then, the migration execution unit 241 notifies the communication control unit 23 of a transmission request to the migration aid unit 14 of the switching timing information 629 and a transmission request to the migration aid unit 34 of the switching timing information 6210.

In step S35, the migration execution unit 241 stands by until the communication control unit 23 receives the switching completion 6211 from the migration aid unit 14, and the communication control unit 23 receives the switching completion 6212 from the migration aid unit 34. In a case where the communication control unit 23 received the switching completion 6211 and the switching completion 6212, the migration execution unit 241 obtains the switching completion 6211 and the switching completion 6212, and ends the process.

The operation of the migration aid unit 14 will be described by referring to FIG. 4 and FIG. 14.

In step S84, the migration aid unit 14 completes its standby by the switching timing information 629 being transmitted in step S34. Then, the migration aid unit 14 proceeds with the process to step S85.

In step S85, the migration aid unit 14 stands by until the condition of the switching timing information 629 is met.

In step S86, the migration aid unit 14 stops operation of the cycle computation unit 11.

In step S87, the migration aid unit 14 notifies the communication control unit 13 of a transmission request to the migration execution unit 241 of the switching completion 6211.

The operation of the migration aid unit 34 will be described by referring to FIG. 4 and FIG. 15.

In step S93, the migration aid unit 34 completes its standby when the reception of the computation result information 627 is started by the computation execution unit 211 starting the computation process in step S43 of FIG. 11. Then, the migration aid unit 34 proceeds with the process to step S94.

In step S94, the migration aid unit 34 notifies the communication control unit 33 of a transmission request to the migration execution unit 241 of the switching preparation completion 628.

In step S95, the migration aid unit 34 stands by until the communication control unit 33 receives the switching timing information 6210 from the migration execution unit 241. In a case where the communication control unit 33 received the switching timing information 6210, the migration aid unit 34 obtains the switching timing information 6210.

In step S96, the migration aid unit 34 stands by until the condition of the switching timing information 6210 is met.

In step S97, the migration aid unit 34 deletes the migration source control apparatus 10 from the communication destination of the input/output control unit 31. Thus, the input/output control unit 31 will no longer perform the notification of the transmission request of the measurement value information 621 and obtaining of the computation result information 622.

In step S98, the migration aid unit 34 notifies the communication control unit 33 of a transmission request to the migration execution unit 241 of the switching completion 6212.

### State After Completion of Migration

The state after completion of migration is a state in which the migration destination control apparatus 20 cooperatively operates with the input/output apparatus 30 through the network 91 to control the control target 40. At this time, in the migration destination control apparatus 20, the computation execution unit 211 executes the computation process, and the control target 40 is controlled based on the computation result of the computation process. At this time, the migration destination control apparatus 20 is set to the communication destination of the input/output control unit 31 by the process of the state during migration mentioned above.

The operation of the control migration system 100 in the state after completion of migration is a same as the state before start of migration except for a point where the migration destination control apparatus 20 controls the control target 40 instead of the migration source control apparatus 10. In other words, as illustrated in FIG. 5, in the state after completion of migration, the computation execution unit 211 performs the computation process instead of the computation execution unit 111, and the measurement value information 624 and the computation result information 627 become transmitted and received between the computation execution unit 211 and the input/output control unit 31.

### Example of State of Computation Data Unit 22

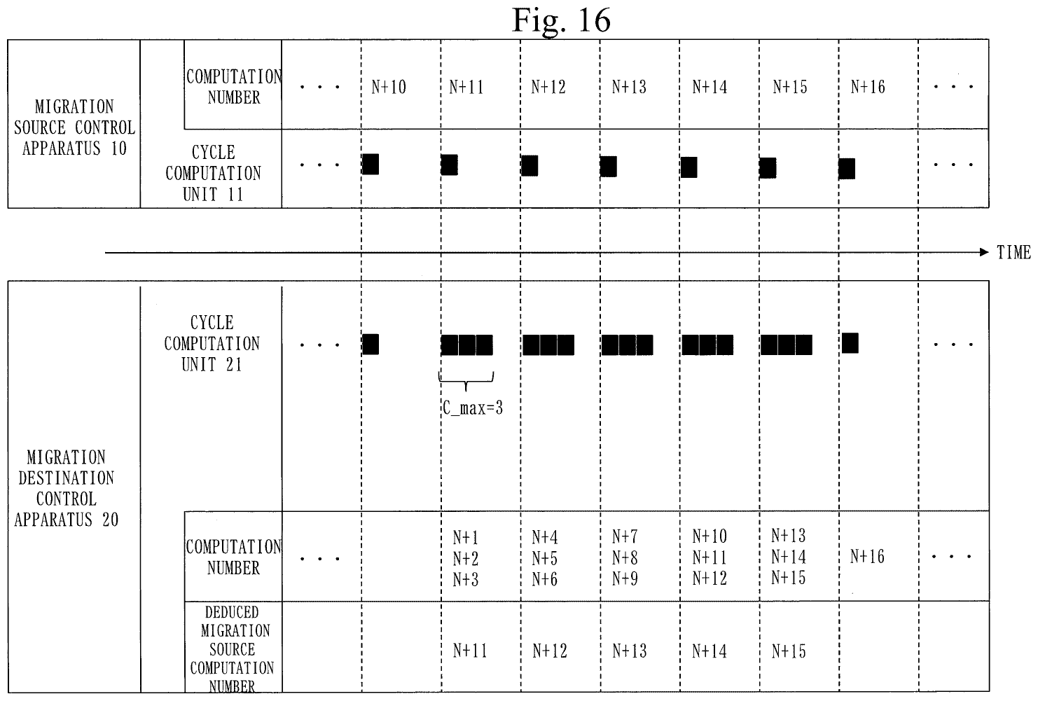

An example of a state of the computation data unit 22 in the state during migration according to Embodiment 1 will be described by referring to FIG. 16.

In the example of FIG. 16, a reproduction computation is being performed with the starting point computation number=N and C_max=3. In other words, a computation number in the specified cycle where the migration aid unit 14 generates the initial synchronization information 626 in step S83 of FIG. 14 is N.

By completion of the state during initial synchronization, the initial synchronization unit 242 obtains from the migration source control apparatus 10, an initial synchronization information 626 that includes information that necessitates synchronization until computation process completion of the starting point computation number N by the computation execution unit 111 that the computation data unit 12 manages. Then, the initial synchronization unit 242, along with synchronizing the initial synchronization information 626 with the computation data unit 22, reflects the initial synchronization information 626 in the reproduction data unit 25. In FIG. 16, at a point in time when a computation number of when the state during initial synchronization is to be completed is N+10, the synchronization of the information that necessitates synchronization until the computation process completion of the starting point computation number N is completed. In other words, a situation is shown where transfer time of the information that necessitates the synchronization is longer than the computation cycle T_cyc[ms].

By the completion of the state during initial synchronization, the computation reproduction unit 212 sets the measurement value information 624 that is obtained from the input/output apparatus 30 in the measurement value information buffer that the reproduction data unit 25 manages.

In the state during reproduction computation, the computation reproduction unit 212 performs the reproduction computation of the computation execution unit 111 of the migration source control apparatus 10 based on the information that the computation data unit 22 and the reproduction data unit 25 manage and the value of the synchronization time counter. At this time, the computation reproduction unit 212 does not necessitate transfer from the migration source control apparatus 10 of the information that necessitates the synchronization.

In FIG. 16, the reproduction computation is started from a point in time when the computation number of the computation execution unit 111 is N+11.

First, the computation reproduction unit 212 sets N+11 to the deduced migration source computation number in step S59 of FIG. 12. Then, the computation reproduction unit 212 executes three times' worth of computation processes, N+1, N+2, and N+3, since C_max=3. Even when three times' worth of computation processes are executed, computation number “N+3” of the computation process that the computation reproduction unit 212 executed is less than the deduced migration source computation number “N+11”. Consequently, the process is returned to step S56 at step S61 of FIG. 12.

Then, in a next computation cycle, the computation reproduction unit 212 sets N+12 to the deduced migration source computation number in step S59 of FIG. 12. Then, the computation reproduction unit 212 executes three times' worth of computation processes, N+4, N+5, and N+6, since C_max=3. Even when three times' worth of the computation processes are executed, computation number “N+6” of the computation process that the computation reproduction unit 212 executed is less than the deduced migration source computation number “N+12”. Consequently, the process is returned to step S56 at step S61 of FIG. 12.

In a computation cycle after a same process is repeated several times, the computation reproduction unit 212 sets N+15 to the deduced migration source computation number at step S59 of FIG. 12. Then, the computation reproduction unit 212 executes computation processes N+13, N+14, and N+15. Then, computation number “N+15” of the computation process that the computation reproduction unit 212 executed is no longer less than the deduced migration source computation number “N+15”. Consequently, synchronization of data between the computation data unit 12 of the migration source control apparatus 10 and the computation data unit 22 of the migration destination control apparatus 20 is completed.

As described, it will be possible to synchronize the computation data unit 22 with the computation data unit 12 even in a case where the transfer time of the information that necessitates the synchronization is longer than the computation cycle T_cyc[ms].

In the state during switching control, execution by the computation execution unit 211 is started, and a computation result that is a same as the computation execution unit 111 is generated. Consequently, the computation data unit 22 will be in a synchronized state with the computation data unit 12 even in computation cycles of when the computation number is N+16 and onwards. By cooperative operation of the migration control unit 24, the migration aid unit 14, and the migration aid unit 34 in this state, a switch from the migration source control apparatus 10 to the migration destination control apparatus 20 is performed, and the migration is completed.

By the above, while trying not to affect a production facility that is the control target 40, the state of the computation process of the migration source control apparatus 10 can be synchronized with the state of the migration destination control apparatus 20, and the migration can be completed.

### Effect of Embodiment 1

As described above, in the control migration system 100 according to Embodiment 1, the information that necessitates the synchronization of the migration source control apparatus 10 in the specified cycle by the initial synchronization unit 242 is synchronized with the migration destination control apparatus 20. After that, the computation reproduction unit 212 executes the reproduction computation of the computation process by the computation execution unit 111 without necessitating transfer of content that necessitates the synchronization of the migration source control apparatus 10 to have the migration destination control apparatus 20 to be in a state that is synchronized with the migration source control apparatus 10.

Thus, it will be possible to synchronize the computation data unit 22 with the computation data unit 12 even in a case where the transfer time of the information that necessitates the synchronization is longer than the computation cycle T_cyc[ms]. As a result, while trying not to affect the production facility that is the control target 40, the state of the computation process of the migration source control apparatus 10 can be synchronized with the state of the migration destination control apparatus 20, and the migration can be completed.

### Other Configurations

### <Variation 1>

In Embodiment 1, each functional element was enabled by software. As Variation 1, however, each functional element may be enabled by hardware. Points different from Embodiment 1 will be described with regard to this Variation 1.

In a case where each functional element is enabled by hardware, the migration source control apparatus 10 includes an electronic circuit instead of the processor 101, the memory 102, and the storage 103. The electronic circuit is a dedicated circuit to enable functions of each functional element, the memory 102, and the storage 103.

In a case where each functional element is enabled by hardware, the migration destination control apparatus 20 includes the electronic circuit instead of the processor 201, the memory 202, and the storage 203. The electronic circuit is a dedicated circuit to enable the functions of each functional element, the memory 202, and the storage 203.

In a case where each functional element is enabled by hardware, the input/output apparatus 30 includes the electronic circuit instead of the processor 301, the memory 302, and the storage 303. The electronic circuit is a dedicated circuit to enable the functions of each functional element, the memory 302, and the storage 303.

A single circuit, a composite circuit, a programmed processor, a parallel programmed processor, a logic IC, a GA, an ASIC, and an FPGA are expected to be the electronic circuit. GA is an abbreviation for Gate Array. ASIC is an abbreviation for Application Specific Integrated Circuit. FPGA is an abbreviation for Field-Programmable Gate Array.

Each functional element may be enabled by one electronic circuit, or each functional element may be enabled by being distributed to a plurality of electronic circuits.

### <Variation 2>

As Variation 2, some of each functional element may be enabled by hardware, and the rest of each functional element may be enabled by software.

A processor 51, a memory 52, a storage 53, and the electronic circuit are called processing circuitry. In other words, functions of each functional element are enabled by the processing circuitry.

### Embodiment 2

Embodiment 2 differs from Embodiment 1 in that Embodiment 2 collates content of the computation data unit 22 that is updated by the reproduction computation by the computation reproduction unit 212 with content of the computation data unit 12 that is updated by the computation process by the computation execution unit 111. In Embodiment 2, this differing point will be described, and descriptions on points that are same will be omitted.

### Description of Configuration

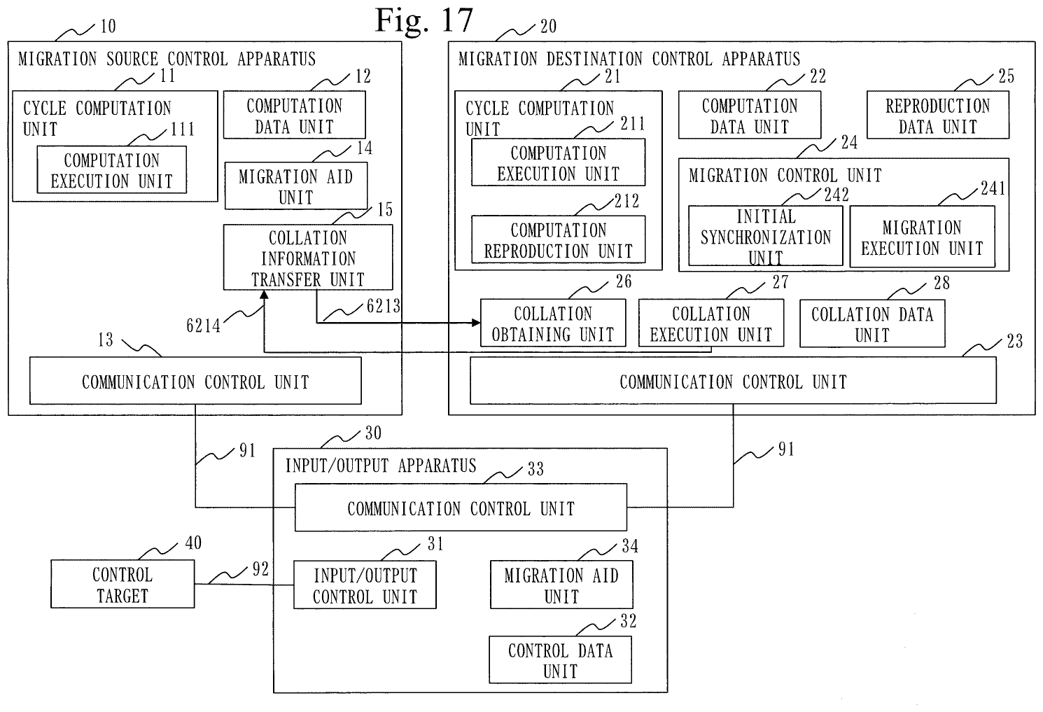

A configuration of a control migration system 100 according to Embodiment 2 will be described by referring to FIG. 17.

Functions of each apparatus, the migration source control apparatus 10, the migration destination control apparatus 20, and the input/output apparatus 30 that the control migration system 100 includes, will be described.

### Functions of Migration Source Control Apparatus 10

The migration source control apparatus 10 differs from the migration source control apparatus 10 illustrated in FIG. 1 in that the migration source control apparatus 10 includes a collation information transfer unit 15 as a functional element.

In addition to the functions described in Embodiment 1, the migration aid unit 14 has a function to start execution of the collation information transfer unit 15.

The collation information transfer unit 15 transfers migration source collation information 6213 to the migration destination control apparatus 20. The migration source collation information 6213 is information of which a processing result needs to be collated for each computation among the information that the computation data unit 12 manages. For example, the migration source collation information 6213 is some of the internal data such as the measurement number used, the computation number, the computation result, and the like.

### Functions of Migration Destination Control Apparatus 20

The migration destination control apparatus 20 differs from the migration destination control apparatus 20 illustrated in FIG. 1 in that the migration destination control apparatus 20 includes a collation obtaining unit 26, a collation execution unit 27, and a collation data unit 28 as functional elements.

In addition to the functions described in Embodiment 1, the computation reproduction unit 212 has a function to generate reproduction collation information and to save the reproduction collation information in a reproduction collation information buffer of the collation data unit 28. The reproduction collation information is configured in a way that a configuration is a same as a configuration of the migration source collation information 6213.

The collation obtaining unit 26 obtains the migration source collation information 6213 that is transferred from the collation information transfer unit 15, and saves the migration source collation information 6213 in a migration source collation information buffer of the collation data unit 28.

The collation execution unit 27 collates, of the collation data unit 28, information in the migration source collation information buffer and information in the reproduction collation information buffer, and verifies whether or not the information in the migration source collation information buffer and the information in the reproduction collation information buffer match. In a case where the information in the migration source collation information buffer and the information in the reproduction collation information buffer do not match the collation execution unit 27 increases reliability by performing an error process. For example, the collation execution unit 27 performs a retry process or a process of migration suspension. In a case where the information in the migration source collation information buffer and the information in the reproduction collation information buffer matched, the collation execution unit 27 transmits collation completion 6214 to the collation information transfer unit 15. The collation completion 6214 is not transmitted for every match confirmation, but is transmitted after collation completion of all data.

The collation data unit 28 manages information for collation. Specifically, the collation data unit 28, using the migration source collation information buffer, manages the migration source collation information 6213 that the collation obtaining unit 26 obtained. The collation data unit 28, using the reproduction collation information buffer, manages the reproduction collation information that the computation reproduction unit 212 generated.

The migration execution unit 241 has a function to start execution of the collation execution unit 27 and the collation obtaining unit 26 and a function to stand by for execution completion of the collation execution unit 27.

### Description of Operation

Operation of the control migration system 100 according to Embodiment 2 will be described.

Operation procedure of the control migration system 100 according to Embodiment 2 is equivalent to a control migration method according to Embodiment 2. A program that enables the operation of the control migration system 100 according to Embodiment 2 is equivalent to a control migration program according to Embodiment 2.

Among three states, a state before start of migration, a state during migration, and a state after completion of migration, operation in the state during migration differs from the operation in Embodiment 1.

### State During Migration

The operation of the control migration system 100 in the state during migration according to Embodiment 2 will be described by referring to FIG. 17 to FIG. 23.

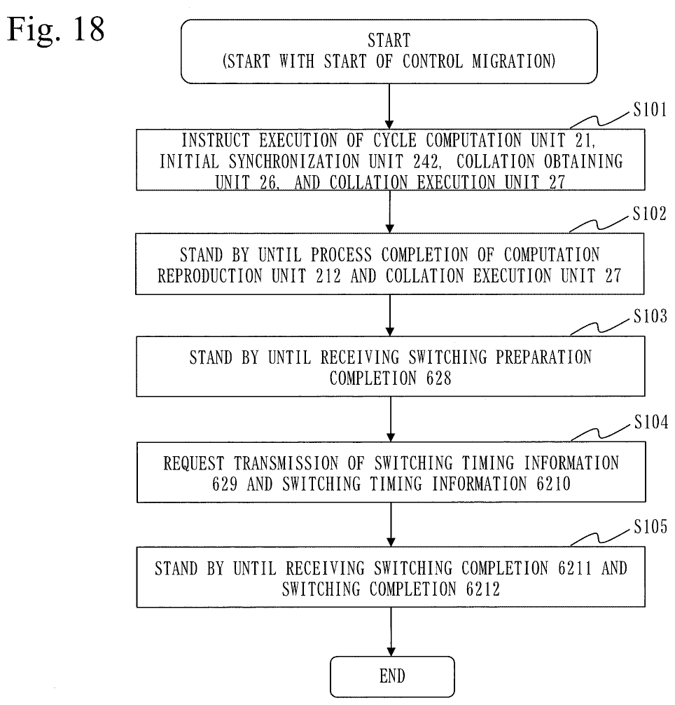

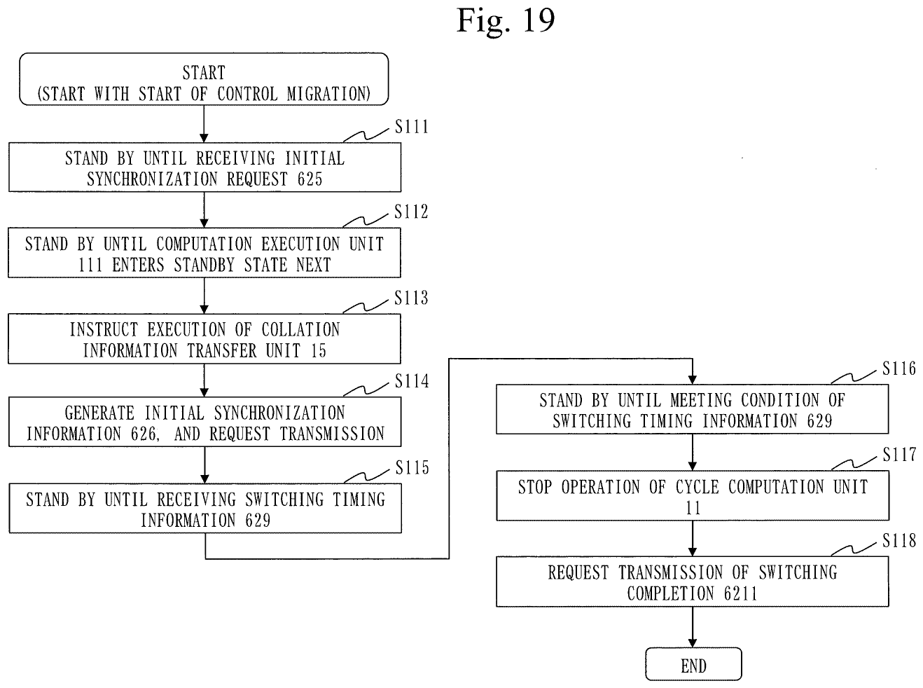

When control migration is started, an operation flow of the migration execution unit 241 of the migration destination control apparatus 20 (refer to FIG. 18) is started. An operation flow of the migration aid unit 14 of the migration source control apparatus 10 (refer to FIG. 19) is started. An operation flow of the migration aid unit 34 of the input/output apparatus 30 (refer to FIG. 15) is started.

Operation of the migration execution unit 241 according to Embodiment 2 will be described by referring to FIG. 18.

Processes of step S103 to step S105 are same as processes of step S33 to step S35 of FIG. 10.

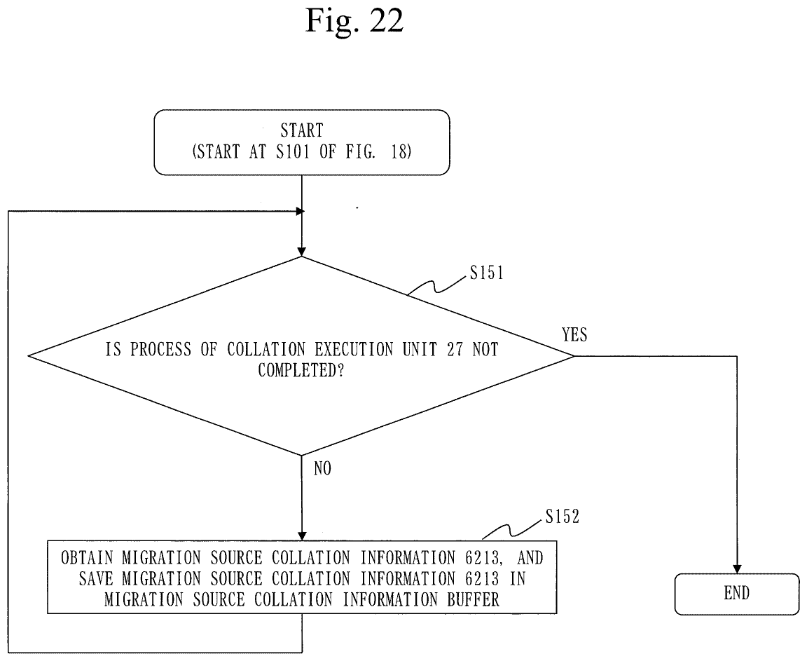

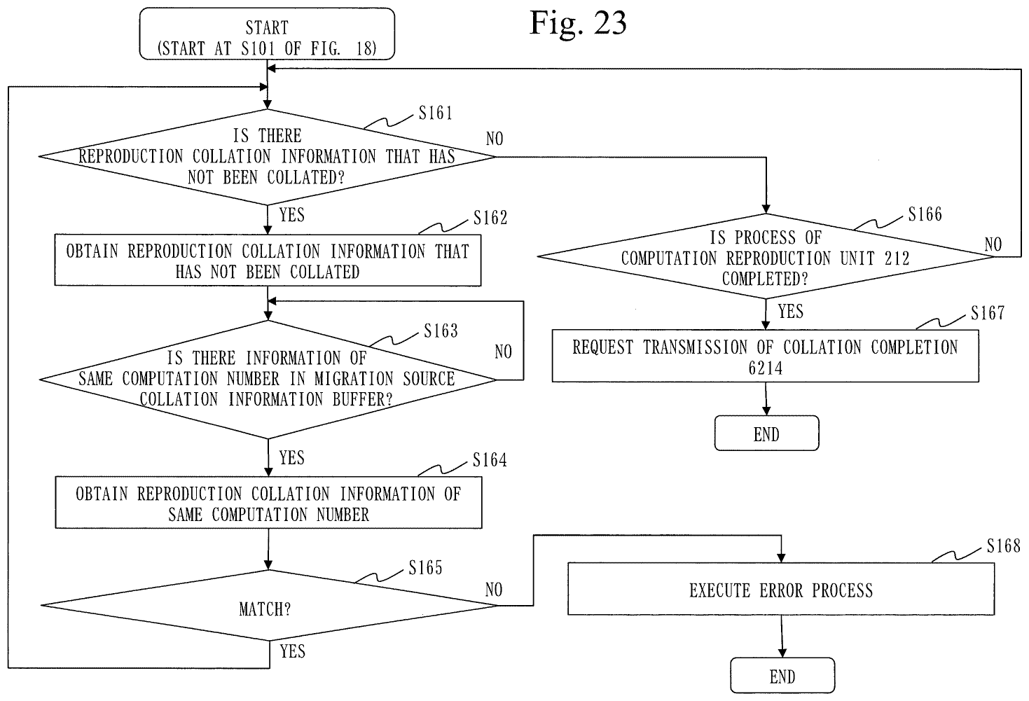

In step S101, the migration execution unit 241 starts execution of an operation flow of the collation obtaining unit 26 (refer to FIG. 22) and an operation flow of the collation execution unit 27 (refer to FIG. 23) in addition to the operation flow of the cycle computation unit 21 and an operation flow of the initial synchronization unit 242. The operation flow of the cycle computation unit 21, the operation flow of the initial synchronization unit 242, the operation flow of the collation obtaining unit 26, and the operation flow of the collation execution unit 27 are executed in parallel.

In step S102, the migration execution unit 241 stands by until a process of the collation execution unit 27 is completed in addition to a process of the computation reproduction unit 212.

Operation of the migration aid unit 14 according to Embodiment 2 will be described by referring to FIG. 19.

Processes of step S111 to step S112 are same as processes of step S81 to step S82 of FIG. 14. Processes of step S114 to step S118 are same as processes of step S83 to step S87 of FIG. 14.

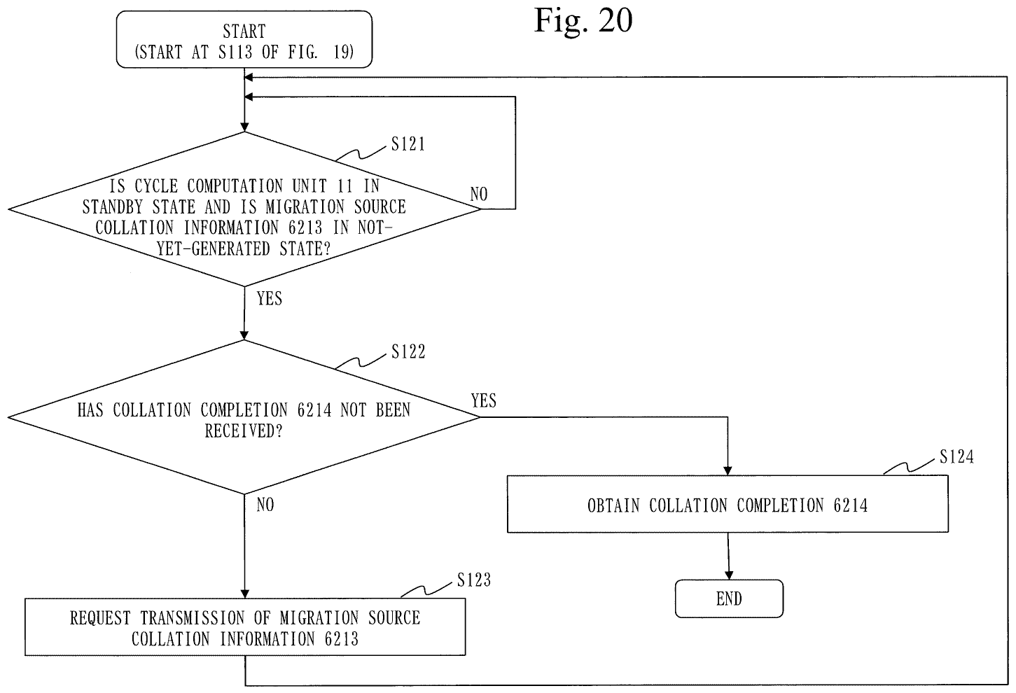

In step S113, the migration aid unit 14 starts execution of an operation flow of the collation information transfer unit 15 (refer to FIG. 20). The operation flow of the collation information transfer unit 15 is executed in parallel with a different operation flow.

Operation of the collation information transfer unit 15 according to Embodiment 2 will be described by referring to FIG. 20.

In step S121, in a case where the computation execution unit 111 of the cycle computation unit 11 is in a standby state, and a migration source collation information 6213 of a current computation number that the computation data unit 12 manages has not been generated, the collation information transfer unit 15 proceeds with the process to step S122. On the other hand, if not, the collation information transfer unit 15 returns the process to step S121. In a case where the current computation number match the computation number that is included in the initial synchronization information 626, the collation information transfer unit 15 may return the process to step S121 and not proceed with the process to step S122.

In step S122, in a case where the communication control unit 13 has not received the collation completion 6214 from the collation obtaining unit 26, the collation information transfer unit 15 proceeds with the process to step S123. On the other hand, in a case where the collation completion 6214 has been received, the collation information transfer unit 15 proceeds with the process to step S124. In step S124, the collation information transfer unit 15 obtains the collation completion 6214 from the communication control unit 13 and ends the process.

In step S123, the collation information transfer unit 15 generates the migration source collation information 6213. Then, the collation information transfer unit 15 notifies the communication control unit 13 of a transmission request to the collation obtaining unit 26 of the migration source collation information 6213.

The collation information transfer unit 15 necessitates performing the process of step S123 for every computation number. Consequently, execution timing and core allocation of the processor 101 is to be controlled in a way that the process of step S123 can be executed at least once from when the computation execution unit 111 of the cycle computation unit 11 enters the standby state until the computation execution unit 111 of the cycle computation unit 11 is next started up.

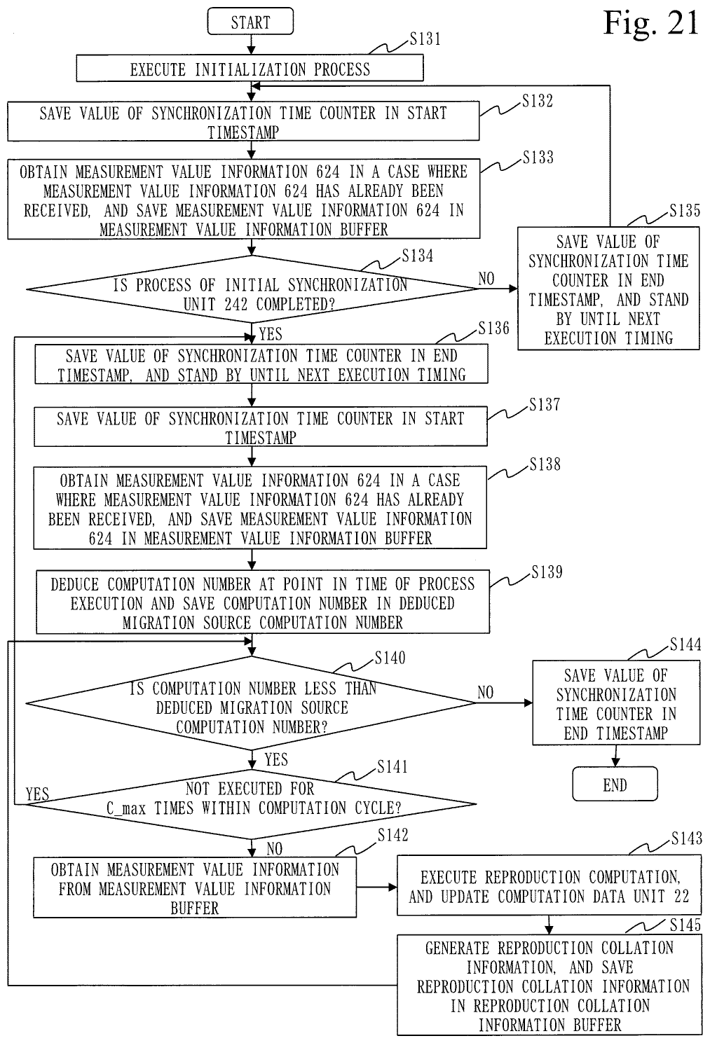

Operation of the computation reproduction unit 212 according to Embodiment 2 will be described by referring to FIG. 21.

Processes of step S131 to step S144 are same as processes of step S51 to step S64 of FIG. 12.

In step S145, the computation reproduction unit 212 generates the reproduction collation information based on the information that the computation data unit 22 manages, and saves the reproduction collation information in the reproduction collation information buffer. The reproduction collation information that is generated here is information that corresponds to a computation number in step S143 that is executed most recently.

Operation of the collation obtaining unit 26 according to Embodiment 2 will be described by referring to FIG. 22.

In step S151, the collation obtaining unit 26 proceeds with the process to step S152 in a case where the operation flow of the collation execution unit 27 is not completed. On the other hand, in a case where the operation flow of the collation execution unit 27 is completed, the collation obtaining unit 26 ends the process.

In step S152, the collation obtaining unit 26 stands by until the communication control unit 23 receives the migration source collation information 6213. In a case where the communication control unit 23 received the migration source collation information 6213, the collation obtaining unit 26 obtains the migration source collation information 6213, and saves the migration source collation information 6213 in the migration source collation information buffer that the collation data unit 28 manages. The collation obtaining unit 26 may set a time limit for a standby, and in a case where the migration source collation information 6213 cannot be obtained within the time limit, may return the process to step S151.

Operation of the collation execution unit 27 according to Embodiment 2 will be described by referring to FIG. 23.

In step S161, in a case where there is reproduction collation information that has not been collated in the reproduction collation information buffer that the collation data unit 28 manages, the collation execution unit 27 proceeds with the process to step S162. On the other hand, in a case where there is no reproduction collation information that has not been collated in the reproduction collation information buffer, the collation execution unit 27 proceeds with the process to step S166. In step S166, in a case where the operation flow of the computation reproduction unit 212 is not completed, the collation execution unit 27 returns the process to step S161. On the other hand, in a case where the operation flow of the computation reproduction unit 212 is completed, the collation execution unit 27 proceeds with the process to step S167. In step S167, the collation execution unit 27 notifies the communication control unit 23 of a transmission request of the collation completion 6214 to the collation information transfer unit 15, and ends the process.

In step S162, the collation execution unit 27 obtains reproduction collation information that has not been collated from the reproduction collation information buffer that the collation data unit 28 manages.

In step S163, in a case where there is collation information of a computation number that is a same as the reproduction collation information that is obtained step S162 in the migration source collation information buffer that the collation data unit 28 manages, the collation execution unit 27 proceeds with the process to step S164. On the other hand, in a case where there is no migration source collation information 6213 of a computation number that is a same as the reproduction collation information, the collation execution unit 27 returns the process to step S163. The collation execution unit 27 may set a time limit to continuation of a state in which there is no migration source collation information 6213 of the computation number that is the same as the reproduction collation information taking a case where a reproduction computation process generated reproduction collation information that includes an incorrect computation number and the like into consideration. And, in a case where the state in which there is no the migration source collation information 6213 of the computation number that is the same as the reproduction collation information exceeds the time limit, the collation execution unit 27 may perform an error process that is a same as step S168 to be described later.

In step S164, the collation execution unit 27 obtains the migration source collation information 6213 of the computation number that is the same as the reproduction collation information from the migration source collation information buffer that the collation data unit 28 manages. Then, the collation execution unit 27 compares the migration source collation information 6213 that is obtained with the reproduction collation information that is obtained in step S162.

In step S165, in a case where the migration source collation information 6213 that is obtained matched the reproduction collation information that is obtained in step S162, the collation execution unit 27 returns the process to step S161. On the other hand, in a case where the migration source collation information 6213 that is obtained did not match the reproduction collation information that is obtained in step S162, the collation execution unit 27 proceeds with the process to step S168.

In step S168, the collation execution unit 27 performs an error process and ends the process.

### Effect of Embodiment 2

As described above, the control migration system 100 according to Embodiment 2 collates the content of the computation data unit 22 that is updated by the reproduction computation by the computation reproduction unit 212 with the content of the computation data unit 12 that is updated by the computation process by the computation execution unit 111. Thus, reliability of the reproduction computation can be increased while having the effect of Embodiment 1.

### Embodiment 3

Embodiment 3 differs from Embodiment 1 and 2 in that Embodiment 3, in a case where a plurality of computation processes are being executed in the migration source control apparatus 10, determines a migration order of the computation processes. In Embodiment 3, this differing point will be described, and descriptions on points that are same will be omitted.

In Embodiment 3, a case where functions are added to Embodiment 1 will be described. It is possible, however, to add functions to Embodiment 2.

A case will be considered where in the migration source control apparatus 10, a plurality of computation processes are executed on a same core in the processor 101, and all of the plurality of computation processes are migrated to the migration destination control apparatus 20 and executed on a same core in the processor 201. In this case, a value of the limited number of times C_max that each computation reproduction unit 212 is possible to set may differ depending on a migration order of which control processes are migrated. Consequently, processing time of the computation reproduction unit 212 may differ depending on the migration order of which the control processes are migrated. Therefore, there is a possibility of total time needed for the migration to change depending on the migration order.

In Embodiment 2, in a case where the processing time of the computation reproduction unit 212 is possible to be inferred in advance, an order of which the total time needed for the migration is minimized is inferred, and the migration is performed in that order.

### Description of Configuration

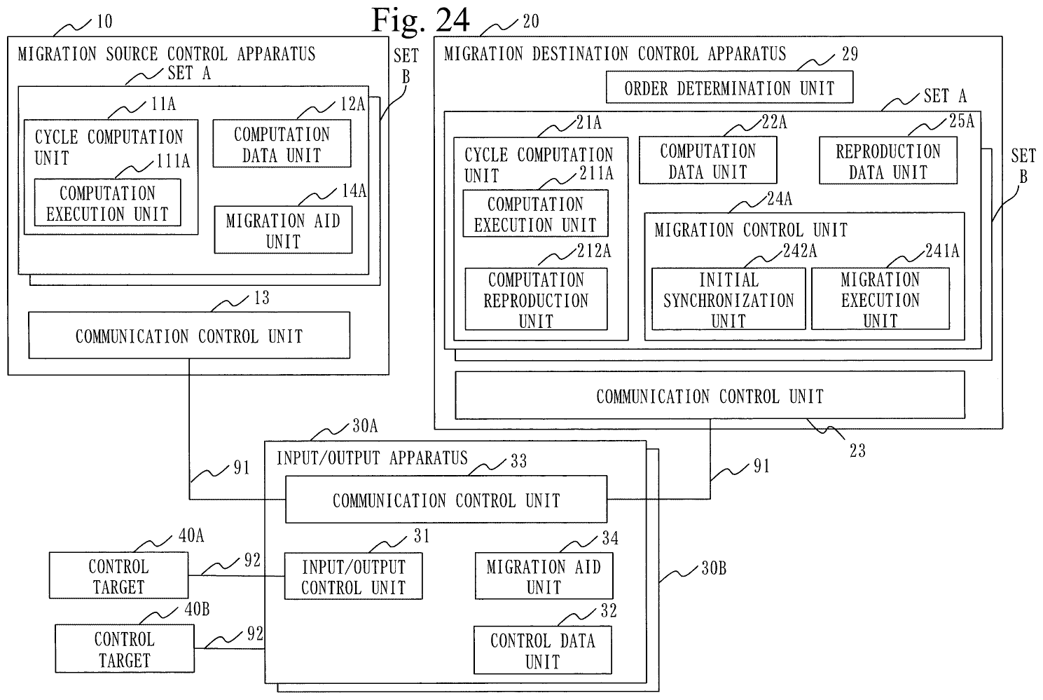

A configuration of a control migration system 100 according to Embodiment 3 will be described by referring to FIG. 24.

The control migration system 100 includes the migration source control apparatus 10, the migration destination control apparatus 20, and a plurality of input/output apparatuses 30. The migration source control apparatus 10, the migration destination control apparatus 20, and each input/output apparatus 30 are connected through the network 91. Each input/output apparatus 30 is connected to a corresponding control target 40 through the transmission channel 92. Each input/output apparatus 30 is controlled independently of other input/output apparatuses 30.

In FIG. 24, the control migration system 100 includes two input/output apparatuses 30, an input/output apparatus 30A and an input/output apparatus 30B. The input/output apparatus 30A is connected to a control target 40A. The input/output apparatus 30B is connected to a control target 40B. The control migration system 100 may include three or more input/output apparatuses 30.

Functions of each apparatus, the migration source control apparatus 10, the migration destination control apparatus 20, and the input/output apparatus 30 that the control migration system 100 includes, will be described.

### Functions of Migration Source Control Apparatus 10

The migration source control apparatus 10 differs from the migration source control apparatus 10 illustrated in FIG. 1 in that the migration source control apparatus 10 includes a set of the cycle computation unit 11, the computation data unit 12, and the migration aid unit 14 for each of the plurality of computation processes. The computation process is provided for each input/output apparatus 30.

In FIG. 24, the migration source control apparatus 10 includes set A of a cycle computation unit 11A, a computation data unit 12A, and a migration aid unit 14A, for computation process A that corresponds to the input/output apparatus 30A. The migration source control apparatus 10 includes set B of a cycle computation unit 11B, a computation data unit 12B, and a migration aid unit 14B, for computation process B that corresponds to the input/output apparatus 30B.

### Functions of Migration Destination Control Apparatus 20

The migration destination control apparatus 20 differs from the migration destination control apparatus 20 illustrated in FIG. 1 in that the migration destination control apparatus 20 includes an order determination unit 29.

The migration destination control apparatus 20 differs from the migration destination control apparatus 20 illustrated in FIG. 1 in that the migration destination control apparatus 20 includes a set of the cycle computation unit 21, the computation data unit 22, the migration control unit 24, and the reproduction data unit 25 for each of the plurality of computation processes. The computation process is provided for each input/output apparatus 30.

In FIG. 24, the migration destination control apparatus 20 includes set A of a cycle computation unit 21A, a computation data unit 22A, a migration control unit 24A, and a reproduction data unit 25A for the computation process A that corresponds to the input/output apparatus 30A. The migration destination control apparatus 20 includes set B of a cycle computation unit 21B, a computation data unit 22B, a migration control unit 24B, and a reproduction data unit 25B for the computation process B that corresponds to the input/output apparatus 30B.

The order determination unit 29 determines the migration order of migrating the plurality of computation processes to an order that a total of time it takes for migration of each computation process will be shortest.

### Functions of Input/Output Apparatus 30

A functional configuration of each input/output apparatus 30 is a same as the functional configuration in Embodiment 1.

### Description of Operation

Operation of the control migration system 100 according to Embodiment 3 will be described.

An operation procedure of the control migration system 100 according to Embodiment 3 is equivalent to a control migration method according to Embodiment 3. A program that enables the operation of the control migration system 100 according to Embodiment 3 is equivalent to a control migration program according to Embodiment 3.

Among the three states, the state before start of migration, the state during migration, and the state after completion of migration, operation in the state before start of migration differs from the operation in Embodiment 1.

### State Before Start of Migration

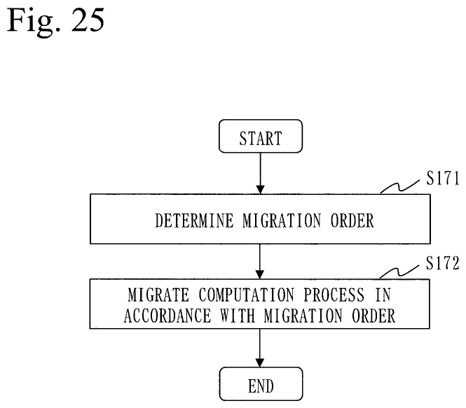

In the state before start of migration, an operation flow of the order determination unit 29 (refer to FIG. 25) is started.

Operation of the order determination unit 29 according to Embodiment 3 will be described by referring to FIG. 25.

In step S171, the order determination unit 29 infers processing time of each computation reproduction unit 212 for each order of which the plurality of computation processes are migrated. The order determination unit 29 calculates a total of the processing time of each computation reproduction unit 212 for each order. Then, the order determination unit 29 determines the migration order to an order of which a total of the processing time will be shortest. An identification method of the order of which the total of the processing time will be shortest can be any method, and for example, is achieved by a full search.

In step S172, the order determination unit 29 instructs each migration control unit 24 to perform migration of the computation process in the migration order that is determined in step S171.

In a case of FIG. 24, in step S171, the order determination unit 29 deduces processing time of a computation reproduction unit 212A and processing time of a computation reproduction unit 212B for each of an order of computation process A to computation process B, and an order of computation process B to computation process A. Then, the order determination unit 29 calculates a total of the processing time of the computation reproduction unit 212A and the processing time of the computation reproduction unit 212B for the order of computation process A to computation process B. The order determination unit 29 calculates a total of the processing time of the computation reproduction unit 212A and the processing time of the computation reproduction unit 212B for the order of computation process B to computation process A. Then, the order determination unit 29 determines an order of which the total of the processing time is shorter as the migration order.

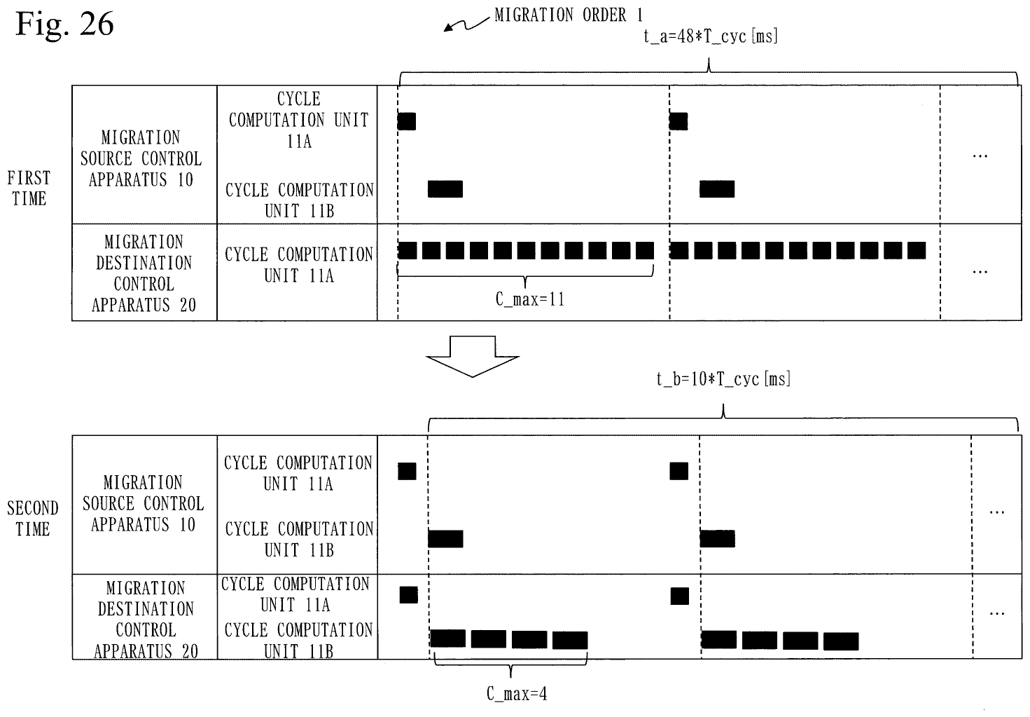

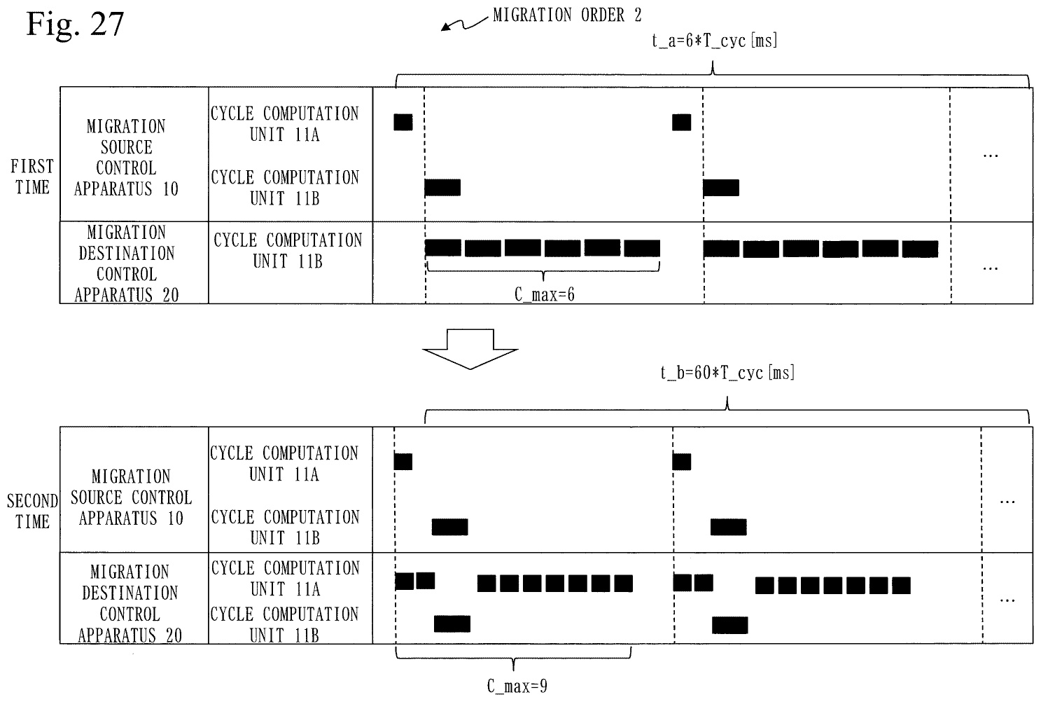

A specific example of a determination method of the migration order according to Embodiment 3 will be described by referring to FIG. 26 and FIG. 27.

In FIG. 26 and FIG. 27, an order in which the cycle computation unit 11A and the cycle computation unit 11B are migrated to the cycle computation unit 21A and the cycle computation unit 21B respectively is determined.

Here, the computation cycle T_cyc[ms] of both the cycle computation unit 11A and the cycle computation unit 11B are same. In the computation reproduction unit 212A and the computation reproduction unit 212B, startup timing is regarded as being adjusted in a way that at least computation cycle C_max>=2 can be achieved. Processing time until meeting a Yes condition of step S54 of operation flows of the computation reproduction unit 212A and the computation reproduction unit 212B (refer to FIG. 12) is regarded as being constant regardless of the migration order. The Yes condition of step S54 is regarded as being met and an inferred value of processing time considered in units of computation cycle T_cyc[ms] from when initial execution of step S57 is started is regarded as being t_a[ms] for the computation reproduction unit 212A and t_b[ms] for the computation reproduction unit 212B. Processing time of a different element is regarded as being constant regardless of the migration order.

Here, values of t_a+t_b in two migration orders below will be inferred.

<Migration Order 1> A case where the migration is to be performed in an order of the cycle computation unit 11A for a first time, and the cycle computation unit 11B for a second time (refer to FIG. 26).

Limited number of times C_max=11 is regarded as being possible to be set in the computation reproduction unit 212A of the cycle computation unit 21A, and a difference between a deduced migration source computation number at a time of starting an initial reproduction computation and a computation number that the computation data unit 22A manages after the initial reproduction computation is regarded as being 480. And, t_a=48 ms*T_cyc[ms] is regarded as being inferred.

Limited number of times C_max=4 is regarded as being possible to be set in the computation reproduction unit 212B of the cycle computation unit 21B, and a difference between the deduced migration source computation number at the time of starting the initial reproduction computation and a computation number that the computation data unit 22B manages after the initial reproduction computation is regarded as being 30. And, t_b=10 ms*T_cyc[ms] is regarded as being inferred.

At this time, t_a+t_b=58*T_cyc[ms].

<Migration Order 2> A case where the migration is to be performed in an order of the cycle computation unit 11B for a first time, and the cycle computation unit 11A for a second time (refer to FIG. 27).

Limited number of times C_max=6 is regarded as being possible to be set in the computation reproduction unit 212B of the cycle computation unit 21B, and the difference between the deduced migration source computation number at the time of starting the initial reproduction computation and the computation number that the computation data unit 22B manages after the initial reproduction computation is regarded as being 30. And, t_a=6 ms*T_cyc[ms] is regarded as being inferred.

C_max=9 is regarded as being possible to be set in the computation reproduction unit 212A of the cycle computation unit 21A, and a difference between the deduced migration source computation number at the time of starting the initial reproduction computation and the computation number that the computation data unit 22A manages after the initial reproduction computation is regarded as being 480, and t_b=60 ms*T_cyc[ms] is regarded as being inferred.

At this time, t_a+t_b=66*T_cyc[ms].

In this case, a value of t_a+t_b is smaller for migration order 1. Consequently, the order of the cycle computation unit 21A to 22B is determined as the migration order.

### Effect of Embodiment 3

As described above, in a case where the plurality of computation processes are being executed in the migration source control apparatus 10, the control migration system 100 according to Embodiment 3 determines the migration order of the computation processes to an order of which the processing time will be short. Thus, time needed for the migration is possible to be shortened while having the effect of Embodiment 1.

“Unit” in the description above may be replaced with “circuit”, “step”, “procedure”, “process”, or “processing circuitry”.

The embodiments and the variations of the present disclosure have been described above. Some of the embodiments and the variations among these embodiments and the variations may be combined and executed. Any one of or some of the embodiments and the variations may partially be executed. The present disclosure is not to be limited to the above embodiments and variations, and various changes are possible as necessary.

### Reference Signs List

100: control migration system; 10: migration source control apparatus; 11: cycle computation unit; 111: computation execution unit; 12: computation data unit; 13: communication control unit; 14: migration aid unit; 15: collation information transfer unit; 20: migration destination control apparatus; 21: cycle computation unit; 211: computation execution unit; 212: computation reproduction unit; 22: computation data unit; 23: communication control unit; 24: migration control unit; 241: migration execution unit; 242: initial synchronization unit; 25: reproduction data unit; 26: collation obtaining unit; 27: collation execution unit; 28: collation data unit; 29: order determination unit; 30: input/output apparatus; 31: input/output control unit; 32: control data unit; 33: communication control unit; 34: migration aid unit; 40: control target; 601: measurement value; 602: computation result; 621: measurement value information; 622: computation result information; 623: measurement value information request; 624: measurement value information; 625: initial synchronization request; 626: initial synchronization information; 627: computation result information; 628: switching preparation completion; 629: switching timing information; 6210: switching timing information; 6211: switching completion; 6212: switching completion; 6213: migration source collation information; 6214: collation completion; 91: network; 92: transmission channel.

1. A migration destination control apparatus to where control of a control target is migrated from a migration source control apparatus that controls the control target by cyclically executing a computation process, the migration destination control apparatus comprising:
processing circuitry to:
obtain information that relates to the computation process of the migration source control apparatus in a specified cycle as initial synchronization information;
based on the initial synchronization information that is obtained, execute the computation process that is executed in the migration source control apparatus from a next computation cycle after the specified cycle to a migration cycle to where control is migrated; and
control the control target by executing the computation process after the migration cycle using a result of the computation process that is executed.

2. The migration destination control apparatus according to claim 1, wherein
the processing circuitry
based on elapsed time that is time from the specified cycle to the migration cycle and time taken for one cycle of the computation process in the migration source control apparatus, deduces the number of execution of the computation process that is executed or to be executed in the migration source control apparatus from a next computation cycle after the specified cycle to the migration cycle, and executes the computation process for as much as the number of execution.

3. The migration destination control apparatus according to claim 2, wherein
the processing circuitry
sets a computation cycle where a process is being executed as the migration cycle, and in a case where the computation process for as much as the number of execution is not completed by when a computation process of a next computation cycle is started in the migration source control apparatus, along with re-setting the computation cycle where the process is being executed to the migration cycle again, adds one to the number of execution.

4. The migration destination control apparatus according to claim 1, wherein
the processing circuitry
obtains, from the migration source control apparatus, collation information that is information to collate process results among information relating to the computation process that is executed in the migration source control apparatus from a next computation cycle after the specified cycle to the migration cycle, and
collates the collation information that is obtained with a result of the computation process that is executed.

5. The migration destination control apparatus according to claim 2, wherein
the processing circuitry
obtains, from the migration source control apparatus, collation information that is information to collate process results among information relating to the computation process that is executed in the migration source control apparatus from a next computation cycle after the specified cycle to the migration cycle, and
collates the collation information that is obtained with a result of the computation process that is executed.

6. The migration destination control apparatus according to claim 3, wherein
the processing circuitry
obtains, from the migration source control apparatus, collation information that is information to collate process results among information relating to the computation process that is executed in the migration source control apparatus from a next computation cycle after the specified cycle to the migration cycle, and
collates the collation information that is obtained with a result of the computation process that is executed.

7. The migration destination control apparatus according to claim 1, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

8. The migration destination control apparatus according to claim 2, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

9. The migration destination control apparatus according to claim 3, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

10. The migration destination control apparatus according to claim 4, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

11. The migration destination control apparatus according to claim 5, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

12. The migration destination control apparatus according to claim 6, wherein the migration source control apparatus controls the control target by cyclically executing a plurality of computation processes, wherein
the processing circuitry
determines a migration order of migrating the plurality of computation processes to an order that a total of time taken for migration of each computation process will be shortest, and
controls in a way that the plurality of computation processes are migrated one by one in accordance with the migration order that is determined.

13. A control migration method to migrate from a migration source control apparatus that controls a control target by cyclically executing a computation process, control of the control target to a migration destination control apparatus, the control migration method comprising:
obtaining information that relates to the computation process of the migration source control apparatus in a specified cycle as initial synchronization information, by the migration destination control apparatus;
executing, based on the initial synchronization information, the computation process that is executed in the migration source control apparatus from a next cycle after the specified cycle to a migration cycle to where control is migrated, by the migration destination control apparatus; and
controlling the control target by executing the computation process after the migration cycle using a result of the computation process that is executed based on the initial synchronization information, by the migration destination control apparatus.

14. A non-transitory computer readable medium storing a control migration program to migrate from a migration source control apparatus that controls a control target by cyclically executing a computation process, control of the control target to a migration destination control apparatus, the control migration program that causes a computer to execute:
an initial synchronization process to obtain information that relates to the computation process of the migration source control apparatus in a specified cycle as initial synchronization information;
a computation reproduction process, based on the initial synchronization information that is obtained by the initial synchronization process, to execute the computation process that is executed in the migration source control apparatus from a next cycle after the specified cycle to a migration cycle to where control is migrated; and
a computation process to control the control target by executing the computation process after the migration cycle using a result of the computation process that is executed by the computation reproduction process.
